(19) United States
(12) Patent Application Publication
(10) Pub. No.: US 2009/0322183 A1
(43) Pub. Date: Dec. 31, 2009

(54) INERTIAL SENSOR AND INERTIAL DETECTING DEVICE

(75) Inventors: Takashi Kawakubo, Kanagawa-ken (JP); Toshihiko Nagano, Kanagawa-ken (JP); Michihiko Nishigaki, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/488,691

(22) Filed: Jun. 22, 2009

(30) Foreign Application Priority Data
Jun. 30, 2008 (JP) 2008-171826

(51) Int. Cl. G01P 15/09

(52) U.S. Cl. 310/329

(57) ABSTRACT

An inertial sensor includes a first beam, a first proof mass section and a first upper surface stopper section. The first beam extends in a first direction in a plane parallel to a major surface of a substrate and is held with a spacing from the major surface of the substrate. The first beam has a first detecting section including a first upper side electrode, a first lower side electrode, and a first upper side piezoelectric film provided between the first upper side electrode and the first lower side electrode. The first beam has one end connected to the major surface of the substrate. The first proof mass section is connected to the other end of the first beam and held with a spacing from the major surface of the substrate. The first upper surface stopper section is provided on the opposite side of the first proof mass section from the substrate with a spacing from the first proof mass section.

### CROSS-REFERENCE TO RELATED APPLICATIONS

This application is based upon and claims the benefit of priority from the prior Japanese Patent Application No. 2008-171826, filed on Jun. 30, 2008; the entire contents of which are incorporated herein by reference.

### BACKGROUND OF THE INVENTION

1. Field of the Invention

This invention relates to an inertial sensor and an inertial detecting device based on a piezoelectric element.

2. Background Art

In automobile, electrical, machinery and other industry, there is a growing demand for sensors capable of accurately detecting acceleration, angular acceleration, angular rate and the like. In particular, a small sensor capable of detecting inertial effects such as acceleration, angular acceleration, and angular rate for each two-dimensional or three-dimensional component is desired.

To meet these demands, there is an accelerometer including a gauge resistor and a proof mass body formed in a silicon or other semiconductor substrate. In this accelerometer, the mechanical strain caused in the substrate by acceleration applied to the proof mass body is converted to an electrical signal using the piezoresistive effect. However, the gauge resistance and piezoresistance coefficient have temperature dependence. Thus, in this type of sensor using a semiconductor substrate, temperature variation in the operating environment causes errors in the detected value. Hence, temperature compensation is needed for accurate measurement. In particular, in automobile and other applications, temperature compensation is needed in a considerably wide temperature range from −40 to +120° C., which makes it difficult to use this sensor.

Another sensor is based on the variation of capacitance between two electrode plates. In this sensor, the effect of force, acceleration, magnetism and the like is used to vary the spacing between the two electrode plates, and the variation of this spacing is detected as the variation of capacitance. This technique has the advantage of low manufacturing cost, but has the disadvantage of difficulty in signal processing because the capacitance produced is small.

JP-A-5-026744 (Kokai) (1993) discloses a sensor including four sets of piezoelectric elements on a flexible, disc-shaped substrate to detect acceleration using the sum and difference of the outputs of the piezoelectric elements. However, this technique uses a structure in which piezoelectric elements are provided on a flexible substrate, causing the problem of difficulty in downsizing from the manufacturing point of view.

### SUMMARY OF THE INVENTION

According to an aspect of the invention, there is provided an inertial sensor including: a first beam extending in a first direction in a plane parallel to a major surface of a substrate, held with a spacing from the major surface of the substrate, and having a first detecting section including a first upper side electrode, a first lower side electrode, and a first upper side piezoelectric film provided between the first upper side electrode and the first lower side electrode, the first beam having one end connected to the major surface of the substrate; a first proof mass section connected to other end of the first beam and held with a spacing from the major surface of the substrate; and a first upper surface stopper section provided on the opposite side of the first proof mass section from the substrate with a spacing from the first proof mass section.

According to another aspect of the invention, there is provided an inertial detecting device including: an inertial sensor including: a first beam extending in a first direction in a plane parallel to a major surface of a substrate, held with a spacing from the major surface of the substrate, and having a first detecting section including a first upper side electrode, a first lower side electrode, and a first upper side piezoelectric film provided between the first upper side electrode and the first lower side electrode, the first beam having one end connected to the major surface of the substrate; a first proof mass section connected to other end of the first beam and held with a spacing from the major surface of the substrate; and a first upper surface stopper section provided on the opposite side of the first proof mass section from the substrate with a spacing from the first proof mass section; and a detecting circuit connected to at least one of the first upper side electrode and the first lower side electrode.

### BRIEF DESCRIPTION OF THE DRAWINGS

FIGS. 1A to 1C are schematic views illustrating the configuration of an inertial sensor according to a first embodiment of the invention;

FIG. 2 is a schematic perspective view illustrating the operation of the inertial sensor according to the first embodiment of the invention;

FIGS. 3A to 3C are schematic views illustrating the configuration of an inertial sensor according to a second embodiment of the invention;

FIGS. 4A to 4C are schematic view illustrating the configuration of an inertial sensor according to a first practical example of the invention;

FIGS. 5A to 5E are sequential schematic cross-sectional views illustrating a method for manufacturing an inertial sensor according to the first practical example of the invention;

FIGS. 6A to 6C are schematic views illustrating the configuration of an inertial sensor according to a third embodiment of the invention;

FIG. 7 is a schematic perspective view illustrating the operation of the inertial sensor according to the third embodiment of the invention;

FIGS. 8A and 8B are schematic views illustrating the configuration of an inertial sensor according to a fourth embodiment of the invention;

FIGS. 9A and 9B are schematic perspective views illustrating the operation of the inertial sensor according to the fourth embodiment of the invention;

FIGS. 10A and 10B are schematic views illustrating the configuration of an inertial sensor according to a fifth embodiment of the invention;

FIGS. 11A and 11B are schematic perspective views illustrating the operation of the inertial sensor according to the fifth embodiment of the invention;

FIGS. 12A to 12C are schematic views illustrating the configuration of an inertial sensor according to a sixth embodiment of the invention;

FIGS. 13A to 13C are schematic views illustrating the configuration of an inertial sensor according to a seventh embodiment of the invention;

FIGS. 14A to 14C are schematic views illustrating the configuration of an inertial sensor according to an eighth embodiment of the invention;

FIGS. 15A to 15C are schematic views illustrating the configuration of an inertial sensor according to a ninth embodiment of the invention;

FIGS. 16A and 16B are schematic views illustrating the configuration of an inertial sensor according to a tenth embodiment of the invention;

FIG. 17 is a schematic view illustrating the operating principle of an inertial sensor according to a twelfth embodiment of the invention;

FIGS. 18A and 18B are schematic views illustrating the configuration of an inertial sensor according to the twelfth embodiment of the invention;

FIG. 19 is a schematic perspective view illustrating the operation of the inertial sensor according to the twelfth embodiment of the invention;

FIG. 20 is a schematic view illustrating the operation of the inertial sensor according to the twelfth embodiment of the invention;

FIGS. 21A and 21B are schematic views illustrating the configuration of an inertial sensor according to a thirteenth embodiment of the invention;

FIG. 22 is a schematic perspective view illustrating the operation of the inertial sensor according to the thirteenth embodiment of the invention;

FIGS. 23A and 23B are schematic views illustrating the configuration of an inertial sensor according to a fourteenth embodiment of the invention;

FIG. 24 is a schematic perspective view illustrating the operation of the inertial sensor according to the fourteenth embodiment of the invention;

FIGS. 25A to 25E are schematic plan views showing variations of the inertial sensor according to the embodiments of the invention;

FIGS. 26A and 26B are schematic views illustrating the configuration of an inertial sensor according to a sixteenth embodiment of the invention;

FIGS. 27A and 27B are circuit diagrams illustrating a circuit connected to the inertial sensor according to the sixteenth embodiment of the invention; and

FIGS. 28A and 28B are circuit diagrams illustrating an alternative circuit connected to the inertial sensor according to the sixteenth embodiment of the invention.

### DETAILED DESCRIPTION OF THE INVENTION

Embodiments of the invention will now be described with reference to the drawings.

The drawings are schematic or conceptual. The relationship between the thickness and the width of each portion, and the size ratio between the portions are not necessarily identical to those in reality. Furthermore, the same portion may be shown with different dimensions or ratios in different figures.

In the present specification and drawings, the same elements as those described previously with reference to earlier figures are labeled with like reference numerals, and the detailed description thereof is omitted as appropriate.

### First Embodiment

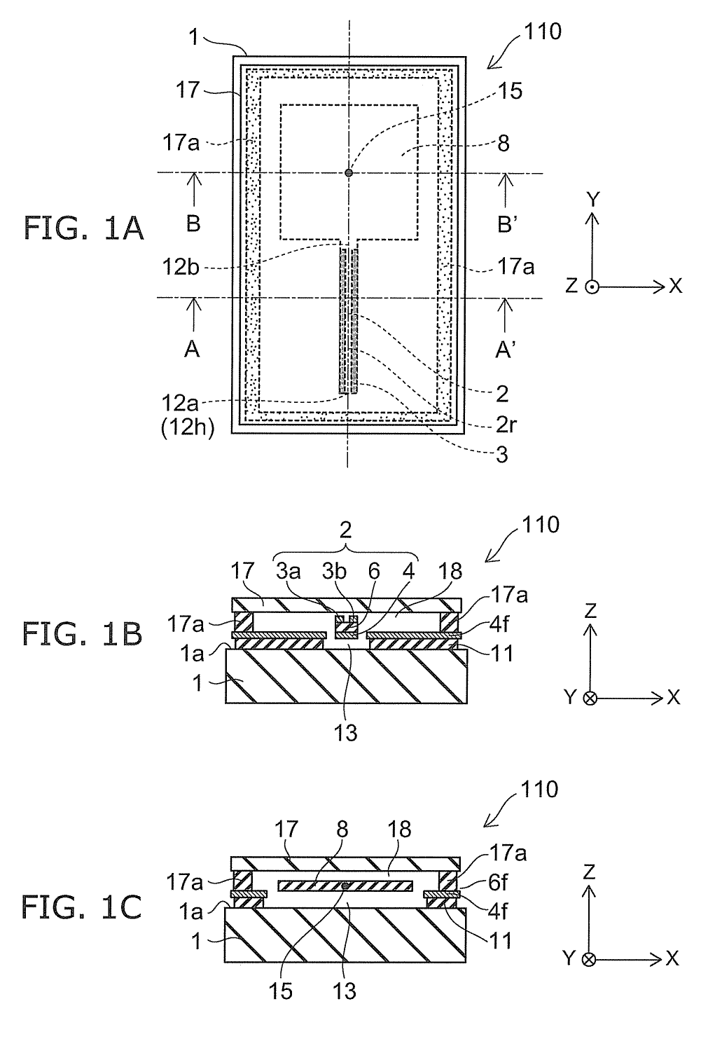

FIG. 1 is a schematic view illustrating the configuration of an inertial sensor according to a first embodiment of the invention.

More specifically, FIG. 1A is a schematic plan view (top view), FIG. 1B is a cross-sectional view taken along line A-A′ in FIG. 1A, and FIG. 1C is a cross-sectional view taken along line B-B′ in FIG. 1A.

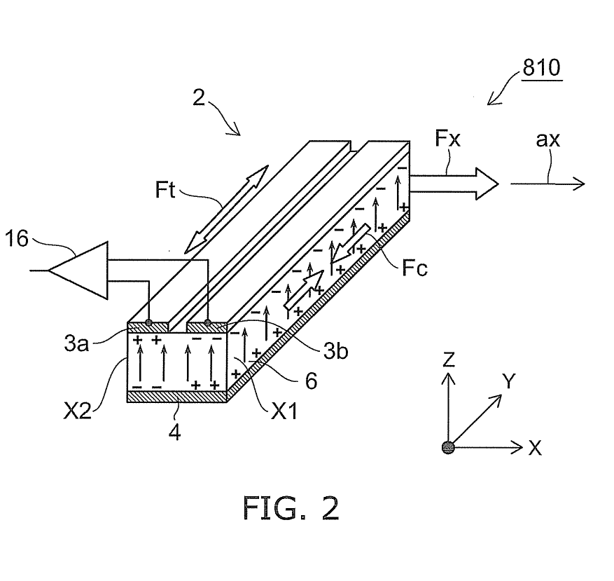

FIG. 2 is a schematic perspective view illustrating the operation of the inertial sensor according to the first embodiment of the invention.

As shown in FIG. 1, the inertial sensor 110 according to the first embodiment of the invention includes a beam 2r (first beam) having a detecting section 2 (first detecting section), a proof mass section 8 (first proof mass section), and an upper surface stopper section 17 (first upper surface stopper section).

The detecting section 2 extends in a first direction (Y-axis direction) in a plane parallel to a major surface 1a of a substrate 1, and is held with a spacing from the major surface 1a of the substrate 1. The detecting section 2 includes a first electrode 3 (first upper side electrode), a second electrode 4 (first lower side electrode), and a first piezoelectric film 6 (first upper side piezoelectric film) provided between the first electrode 3 and the second electrode 4.

The beam 2r includes the aforementioned detecting section 2, and one end 12a of the beam 2r is connected to the major surface 1a of the substrate 1. The one end 12a of the beam 2r serves as a support section 12h of the detecting section 2, and supports the detecting section 2.

In this example, the beam 2r is identical to the detecting section 2, and the one end 12a of the beam 2r is identical to the support section 12h of the detecting section 2. Furthermore, the other end 12b of the beam 2r is identical to the other end of the detecting section 2.

On the other hand, the proof mass section 8 is connected to the other end 12b of the beam 2r (detecting section 2) and held with a spacing from the major surface 1a of the substrate 1.

The upper surface stopper section 17 is provided on the opposite side of the proof mass section 8 from the substrate 1 with a spacing from the proof mass section 8.

Here, as shown in FIG. 1, the direction perpendicular to the major surface 1a of the substrate 1 is assumed as the Z-axis direction, the first direction parallel to the major surface 1a of the substrate 1 is assumed as the Y-axis direction, and the direction perpendicular to the Z-axis direction and the Y-axis direction is assumed as the X-axis direction. That is, the X-axis direction is in a plane parallel to the major surface 1a of the substrate 1 and is orthogonal to the Y-axis direction. Furthermore, the first, second, and third direction are defined as the Y-axis, X-axis, and Z-axis direction, respectively.

The proof mass section 8 can be formed from a material constituting the detecting section 2. For example, the proof mass section 8 can include a first piezoelectric layer film 6f serving as the first piezoelectric film 6, and a second conductive film 4f serving as the second electrode 4. Thus, the proof mass section 8 can include at least one of a first conductive film 3f (first upper side conductive film) serving as the first electrode 3, a second conductive film 4f (first lower side conductive film) serving as the second electrode 4, and a first piezoelectric layer film 6f (first upper side piezoelectric layer film) serving as the first piezoelectric film 6. That is, the proof mass section 8 can include a film which is continuous with at least one of the first electrode 3, the second electrode 4, and the first piezoelectric film 6. However, the invention is not limited thereto, but the proof mass section 8 can be formed from any film structure and any material.

The proof mass section 8 is held with a spacing from the major surface 1a of the substrate 1. The detecting section 2 and the proof mass section 8 are separated from the substrate 1 by a first gap 13.

The upper surface stopper section 17 is provided on the opposite side of the proof mass section 8 from the substrate 1 with a spacing from the proof mass section 8. That is, a second gap 18 is formed between the proof mass section 8 and the upper surface stopper section 17. The upper surface stopper section 17 is provided above the proof mass section 8 and the detecting section 2 via an adhesive layer 17a, for example, and thereby the second gap 18 is formed. The upper surface stopper section 17 only needs to be opposed to at least part of the proof mass section 8 and, for example, may not be opposed to the detecting section 2.

Likewise, the first gap 13 is provided on the substrate 1 side of the detecting section 2, and the second gap 18 is provided on the upper surface stopper section 17 side thereof.

Thus, the inertial sensor 110 according to this embodiment includes a beam 2r extending in a first direction in a plane parallel to a major surface 1a of a substrate 1, held with a spacing from the major surface 1a of the substrate 1, having a detecting section 2 including a first electrode 3, a second electrode 4, and a first piezoelectric film 6 provided between the first electrode 3 and the second electrode 4, and having one end 12a connected to the major surface 1a of the substrate 1; a proof mass section 8 connected to the other end 12b of the beam 2r and held with a spacing from the major surface 1a of the substrate 1; and an upper surface stopper section 17 provided on the opposite side of the proof mass section 8 from the substrate 1 with a spacing from the proof mass section 8.

Thus, the proof mass section 8 and the detecting section 2 are opposed to the substrate 1 across the first gap 13, and to the upper surface stopper section 17 across the second gap 18. Hence, the proof mass section 8 and the detecting section 2 are supported at one end on the major surface 1a of the substrate 1 so as to be movable in the X-axis direction in a plane parallel to the major surface 1a of the substrate 1, and in the Z-axis direction perpendicular to the major surface 1a.

The detecting section 2 and the proof mass section 8 are formed axisymmetrically with respect to the Y axis. That is, the center of gravity 15 of the proof mass section 8 is located on the center line of the detecting section 2. Thus, the first detecting section and the first proof mass section are formed axisymmetrically with respect to the first direction. Furthermore, the center of gravity 15 of the proof mass section 8 is located substantially between the first electrode 3 and a second electrode 4. More specifically, the center of gravity of the first proof mass section is disposed between a first plane including the first upper side electrode and a second plane including the first lower side electrode.

The first electrode 3 in the detecting section 2 is bisected widthwise into a first split electrode 3a and a second split electrode 3b.

The piezoelectric film 6 is polarized in the direction (Z-axis direction) perpendicular to the major surface 1a of the substrate 1.

The first electrode 3, the second electrode 4, and the first piezoelectric film 6 provided between the first electrode 3 and the second electrode 4 are parallel to the major surface 1a of the substrate 1. That is, the stacking direction of the first electrode 3, the second electrode 4, and the first piezoelectric film is perpendicular to the major surface 1a of the substrate 1.

Here, detection of inertial effects by the inertial sensor 110 according to this embodiment upon application of acceleration in the X-axis direction is described.

As shown in FIG. 2, when an acceleration in the X-axis direction is applied to the inertial sensor 110, the acceleration in the X-axis direction causes a force Fx in the X-axis direction to act on the center of gravity 15 of the proof mass section 8, and the detecting section 2 bends in the X-axis direction along the arrow ax with reference to the support section 12h. Consequently, a compressive stress Fc in the Y-axis direction is applied to the side surface X1 of the detecting section 2 on the positive (+) X-axis side. Furthermore, a tensile stress Ft in the Y-axis direction is applied to the side surface X2 of the detecting section 2 on the negative (−) X-axis side.

Here, by the piezoelectric effect, the piezoelectric film 6 is charged in the Z-axis direction. The polarity of charge is opposite between the side surface X1 on the positive X-axis side and the side surface X2 on the negative X-axis side. That is, the voltage between the first split electrode 3a of the first electrode 3 and the second electrode 4 is opposite in polarity to the voltage between the second split electrode 3b of the first electrode 3 and the second electrode 4. Here, the magnitude of the acceleration applied in the X-axis direction can be detected by using a differential amplifier 16, for example, to measure the voltage between the first split electrode 3a′ and the second split electrode 3b.

When an acceleration in the Y-axis direction is applied to the inertial sensor 110, a tensile stress Ft in the Y-axis direction is applied nearly evenly to the piezoelectric film of the detecting section 2 because the center of gravity 15 of the proof mass section 8 is located on the center line of the detecting section 2 and in the plane of the piezoelectric film 6. Thus, at this time, the voltage generated between the second electrode 4 and the first split electrode 3a is equal to the voltage generated between the second electrode 4 and the second split electrode 3b, and the voltage between the first split electrode 3a and the second split electrode 3b vanishes. Hence, the aforementioned differential amplifier 16 connected to the first split electrode 3a and the second split electrode 3b is not sensitive to acceleration in the Y-axis direction.

When an acceleration in the Z-axis direction is applied to the sensor, a force in the Z-axis direction acts on the center of gravity 15 of the proof mass section 8, and the detecting section 2 bends in the Z-axis direction with reference to the support section 12h. Consequently, a compressive stress and a tensile stress in the Y-axis direction are applied to the upper and lower surface side of the piezoelectric film 6 of the detecting section 2, respectively. This deformation is axisymmetric with respect to the Y axis. Thus, the voltage generated between the second electrode 4 and the first split electrode 3a is equal to the voltage generated between the second electrode 4 and the second split electrode 3b, and the voltage between the first split electrode 3a and the second split electrode 3b vanishes. Hence, the aforementioned differential amplifier 16 connected to the first split electrode 3a and the second split electrode 3b is not sensitive to acceleration in the Z-axis direction.

Next, a description is given of the characteristics of the inertial sensor 110 upon application of impact load.

First, the detecting section 2 is formed continuously in the Y-axis direction. Hence, the structural strength is high in the Y-axis direction, and there is no problem with impact load applied in the Y-axis direction.

On the other hand, when an impact load is applied in the X-axis direction, the detecting section 2 and the proof mass section 8 bend in the X-axis direction with reference to the support section 12h in response to the impact stress. Here, the detecting section 2 has a stacked structure of the first electrode 3, the first piezoelectric film 6, and the second electrode 4 stacked in the Z direction. Hence, the structural strength against stress in the X-axis direction, which is parallel to the stacking plane, is relatively higher than the structural strength against stress in the Z direction, for example. Thus, the shape of the proof mass section 8 and the detecting section 2 can be suitably designed so as to avoid practical problems with the structural strength against stress in the X-axis direction. Hence, there is no problem also with impact load applied in the X-axis direction.

On the other hand, the strength against impact load in the Z-axis direction is relatively low due to the stacked structure of the detecting section 2. However, in the inertial sensor 110 according to this embodiment, the substrate 1 is placed on the substrate 1 side of the proof mass section 8 and the detecting section 2 via the first gap 13, and the upper surface stopper section 17 is placed on the opposite side from the substrate 1 via the second gap 18. This can prevent the proof mass section 8 and the detecting section 2 from being destroyed by excessive deformation.

More specifically, when an impact load is applied in the Z-axis direction, the detecting section 2 and the proof mass section 8 bend in the Z-axis direction with reference to the support section 12h in response to the impact stress. The substrate 1 is located close to the proof mass section 8 and spaced by the first gap 13. Hence, with regard to impact force in the negative Z-axis direction, the proof mass section 8 is brought into contact with the substrate 1 and restricted in its bending deformation, which can prevent the detecting section 2 and the like from being broken by application of excessive stress. On the other hand, with regard to impact force in the positive Z-axis direction, the proof mass section 8 is brought into contact with the upper surface stopper section 17, which is opposed to the proof mass section 8 across the second gap 18, and the proof mass section 8 is restricted in its bending deformation, which can prevent the detecting section 2 and the like from being broken by application of excessive stress.

Thus, the inertial sensor 110 according to this embodiment can realize a uniaxial accelerometer being sensitive to acceleration in the X-axis direction and having sufficient resistance to impact force in the X-axis, Y-axis, and Z-axis direction.

More specifically, the detecting section 2 is based on a piezoelectric film, and not on a semiconductor, whose characteristics have large temperature dependence. Thus, this embodiment enables stable operation over a wide temperature range without a temperature compensation circuit. Furthermore, this embodiment has high detection sensitivity and is easy to manufacture and suitable to downsizing. Moreover, this embodiment also has practical impact resistance.

Thus, the inertial sensor 110 according to this embodiment can provide an ultrasmall inertial sensor which is capable of high-accuracy detection without temperature compensation and easy to manufacture.

At least one of the first electrode 3 and the second electrode 4 can include a plurality of split electrodes (split electrode 3a, 3b in this case) extending in the first direction (Y-axis direction). This makes it possible to detect inertial effects in the second direction (X-axis direction) parallel to the major surface 1a of the substrate 1 and orthogonal to the first direction by detecting the potential difference between the split electrodes.

In the foregoing, the first electrode 3 is split into the first split electrode 3a and the second split electrode 3b. However, the second electrode 4 may be split. Furthermore, both the first electrode 3 and the second electrode 4 may be split. In the inertial sensor 110 illustrated in FIG. 1, the electrode near to the substrate 1 is the second electrode 4, and the electrode far from the substrate 1 is the first electrode 3. However, conversely, the electrode near to the substrate 1 may be the first electrode 3, and the electrode far from the substrate 1 may be the second electrode 4. Also in this case, at least one of the first electrode 3 and the second electrode 4 can include split electrodes.

### Second Embodiment

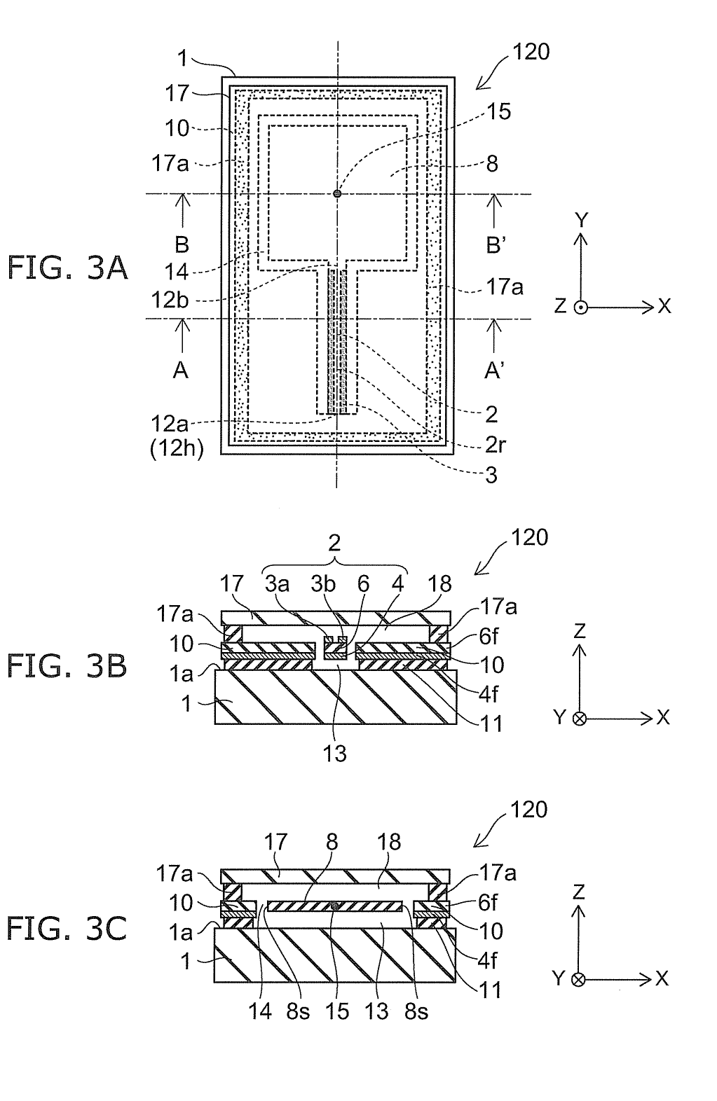

FIG. 3 is a schematic view illustrating the configuration of an inertial sensor according to a second embodiment of the invention.

More specifically, FIG. 3A is a schematic plan view (top view), FIG. 3B is a cross-sectional view taken along line A-A′ in FIG. 3A, and FIG. 3C is a cross-sectional view taken along line B-B′ in FIG. 3A.

As shown in FIG. 3, the inertial sensor 120 according to the second embodiment of the invention further includes a side surface stopper section 10 (first side surface stopper section) in addition to the configuration of the inertial sensor 110 illustrated in FIG. 1. The rest of the configuration can be the same as that of the inertial sensor 110. Hence, the description thereof is omitted, and only the side surface stopper section 10 is described.

In the inertial sensor 120, a side surface stopper section 10 is opposed to the side surface 8s of the proof mass section 8. A third gap 14 is formed between the side surface 8s of the proof mass section 8 and the side surface stopper section 10. The side surface stopper section 10 is fixed to the substrate 1 via a sacrificial layer 11.

The side surface stopper section 10 can illustratively be formed from the material constituting the detecting section 2. The side surface stopper section 10 can illustratively include a first piezoelectric layer film 6f serving as the first piezoelectric film 6, and a second conductive film 4f serving as the second electrode 4. Thus, the side surface stopper section 10 can include at least one of a first conductive film 3f serving as the first electrode 3, a second conductive film 4f serving as the second electrode 4, and a first piezoelectric layer film 6f serving as the first piezoelectric film 6. That is, the side surface stopper section 10 can include a layer which is continuous with at least one of the first electrode 3, the second electrode 4, and the first piezoelectric film 6.

However, the invention is not limited thereto, but the side surface stopper section 10 can be formed from any film structure and any material. In this regard, manufacturing is facilitated by forming the side surface stopper section 10 from at least one of a first conductive film 3f serving as the first electrode 3, a second conductive film 4f serving as the second electrode 4, and a first piezoelectric layer film 6f serving as the first piezoelectric film 6.

The operation of detecting inertial effects by the inertial sensor 120 according to this embodiment is the same as that of the inertial sensor 110, and hence the description thereof is omitted.

Like the inertial sensor 110, the inertial sensor 120 has high strength against impact load in the Y-axis and Z-axis direction. Furthermore, in the inertial sensor 120 according to this embodiment, resistance to impact load in the X-axis direction is higher than in the inertial sensor 110.

More specifically, when an impact load is applied in the X-axis direction, the detecting section 2 and the proof mass section 8 bend in the X-axis direction with reference to the support section 12h in response to the impact stress. Here, the side surface stopper section 10 is formed close to the proof mass section 8 and spaced by the third gap 14. Hence, the proof mass section 8 is brought into contact with the side surface stopper section 10 and restricted in its bending deformation, which can prevent the detecting section 2 and the like from being broken by application of excessive stress. This can further improve the impact resistance in the X-axis direction.

Thus, the inertial sensor 120 according to this embodiment can provide an ultrasmall inertial sensor which is further improved in impact resistance, and is capable of high-accuracy detection without temperature compensation and easy to manufacture.

In the inertial sensor 120 illustrated in FIG. 3, the side surface stopper section 10 is provided so as to surround the proof mass section 8 and the detecting section 2. However, the side surface stopper section only needs to be opposed to at least part of the side surface 8s of the proof mass section 8 and spaced by a third gap 14.

### First Practical Example

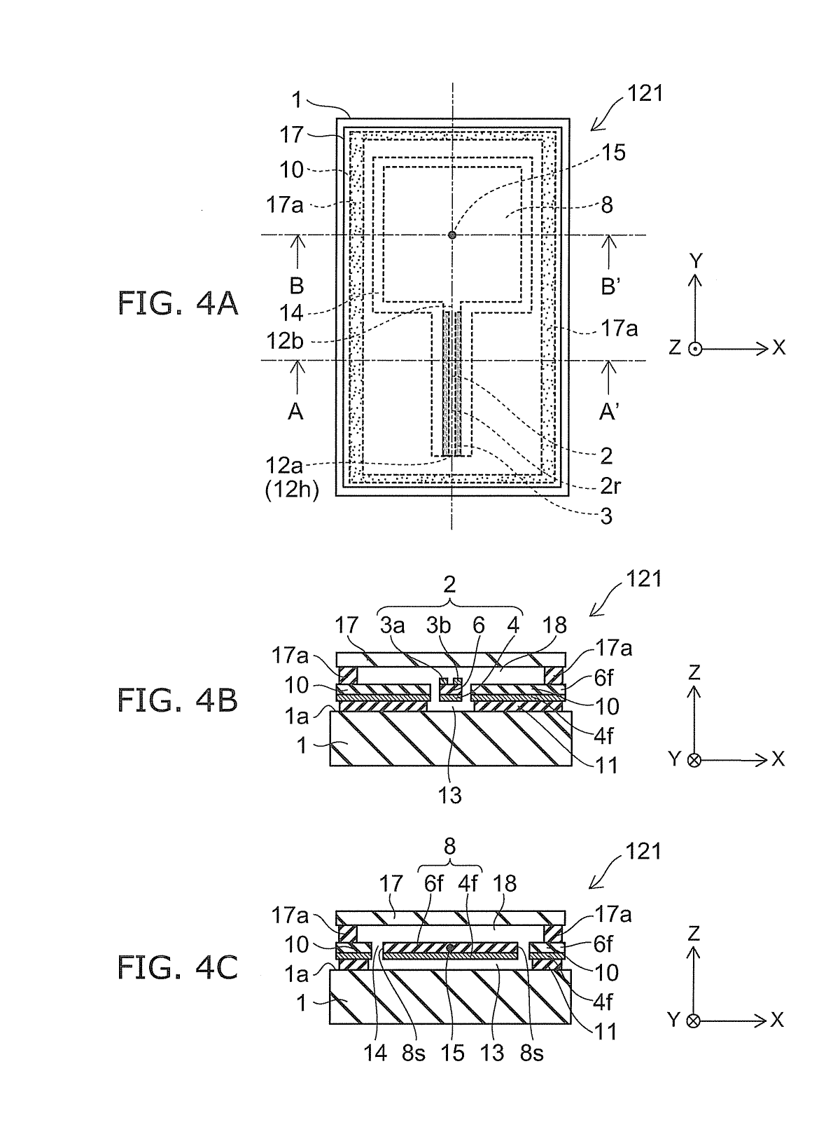

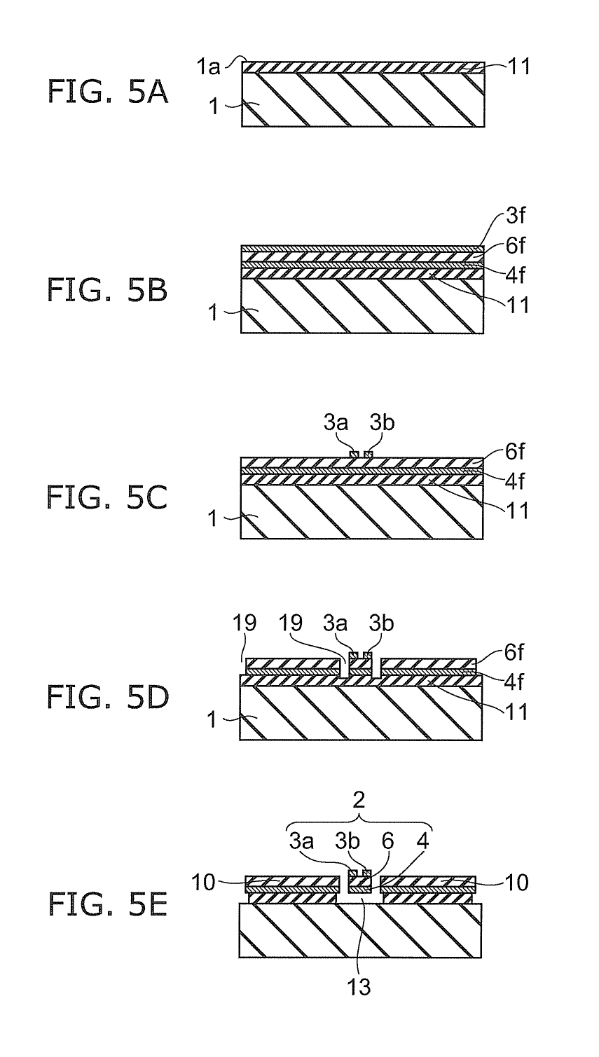

FIG. 4 is a schematic view illustrating the configuration of an inertial sensor according to a first practical example of the invention.

More specifically, FIG. 4A is a schematic plan view (top view), FIG. 4B is a cross-sectional view taken along line A-A′ in FIG. 4A, and FIG. 4C is a cross-sectional view taken along line B-B′ in FIG. 4A.

As shown in FIG. 4, the inertial sensor 121 according to the first practical example of the invention is different from the inertial sensor 120 illustrated in FIG. 3 in that the proof mass section 8 is composed of a first piezoelectric layer film 6f serving as a first piezoelectric film 6 and a second conductive film 4f serving as a second electrode 4. The rest of the configuration is the same as that of the inertial sensor 120, and hence the description thereof is omitted.

In addition to the upper surface stopper section 17, the inertial sensor 121 of this practical example includes a side surface stopper section 10, which further enhances impact resistance in all directions along the X, Y, and Z axis. Furthermore, as described above, the inertial sensor 121 is sensitive to acceleration in the X-axis direction.

Furthermore, the inertial sensor 121 is easy to manufacture because the proof mass section 8 is composed of the first piezoelectric layer film 6f serving as the first piezoelectric film 6, and the second conductive film 4f serving as the second electrode 4, which constitute the detecting section 2. In the following, a method for manufacturing the inertial sensor 121 according to this practical example is described.

FIG. 5 is a sequential schematic cross-sectional view illustrating a method for manufacturing an inertial sensor according to the first practical example of the invention.

This figure corresponds to the cross section taken along line A-A′ in FIG. 4A.

As shown in FIG. 5A, a sacrificial layer 11 is formed on a major surface 1a of a substrate 1. The sacrificial layer 11 can be made of an inorganic, metallic, or organic material that can be selectively etched with respect to other film materials. In this practical example, amorphous silicon is used.

Next, as shown in FIG. 5B, a second conductive film 4f serving as a second electrode 4, a first piezoelectric layer film 6f serving as a first piezoelectric film 6, and a first conductive film 3f serving as a first electrode 3 are formed on the sacrificial layer 11. The first and second conductive film 3f, 4f are made of Al having a thickness of 200 nm, and the first piezoelectric layer film 6f is made of AlN having a thickness of 2 μm, each formed by sputtering. Thus, the first upper side piezoelectric film can include a compound of a metal contained in both of the first upper side electrode and the first lower side electrode.

Next, as shown in FIG. 5C, by patterning using lithography and etching, the first electrode 3 is formed into a first split electrode 3a and a second split electrode 3b.

Next, as shown in FIG. 5D, by patterning using lithography and etching, an etching groove 19 is formed.

Next, as shown in FIG. 5E, the sacrificial layer 11 is removed by selective etching using XeF₂ as an etching gas. This results in a structure in which a detecting section 2 and a proof mass section 8 are held above the major surface 1a of the substrate 1 and spaced by a first gap 13. The etching groove 19 serves as a third gap 14.

Subsequently, for example, an adhesive layer 17a is illustratively provided on the side surface stopper section 10, and an upper surface stopper section 17 is provided thereon. Here, the upper surface stopper section 17 is stuck, for example, with a suitable height so that a second gap 18 is provided between the upper surface stopper section 17 and the proof mass section 8.

Thus, the inertial sensor 121 according to this practical example can be manufactured relatively easily by existing processes.

The aforementioned substrate 1 can illustratively be a semiconductor substrate, for example, in which the differential amplifier 16 and the like illustrated in FIG. 2 are manufactured in advance. This serves to bring the inertial sensor 121 close to the differential amplifier 16, realizing an inertial sensor with lower noise and higher accuracy.

### Third Embodiment

The inertial sensors 110, 120 according to the above first and second embodiment are inertial sensors for detecting acceleration in a direction parallel to the major surface 1a of the substrate 1. In contrast, the inertial sensor according to the third embodiment is an example of the inertial sensor for detecting acceleration in the direction perpendicular to the major surface 1a of the substrate 1.

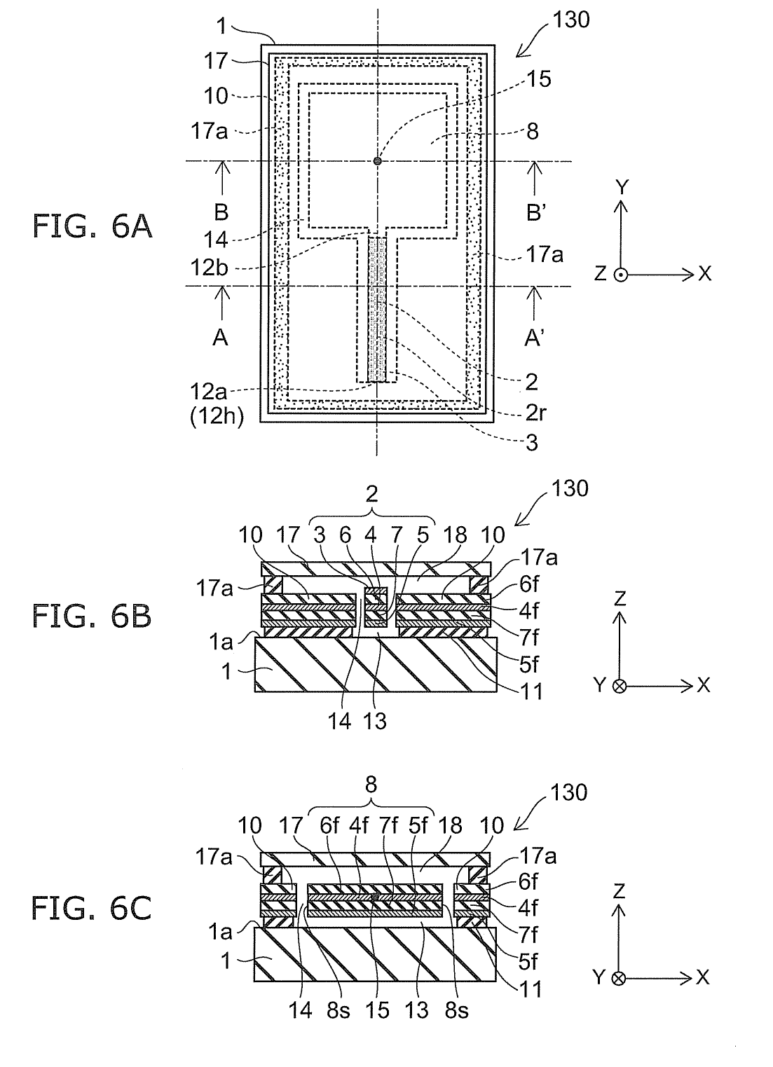

FIG. 6 is a schematic view illustrating the configuration of an inertial sensor according to a third embodiment of the invention.

More specifically, FIG. 6A is a schematic plan view (top view), FIG. 6B is a cross-sectional view taken along line A-A′ in FIG. 6A, and FIG. 6C is a cross-sectional view taken along line B-B′ in FIG. 6A.

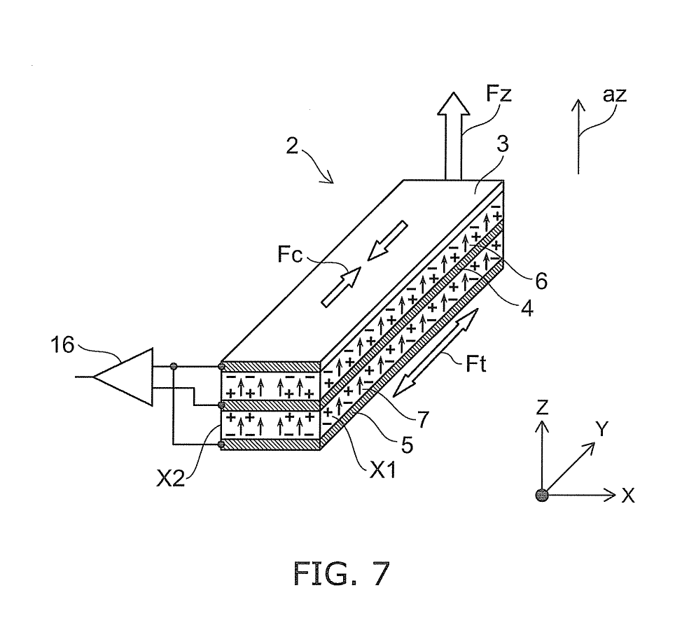

FIG. 7 is a schematic perspective view illustrating the operation of the inertial sensor according to the third embodiment of the invention.

As shown in FIG. 6, the inertial sensor 130 according to the third embodiment of the invention is different from the inertial sensor 120 according to the second embodiment in that the structure of the detecting section 2 is modified.

More specifically, the detecting section 2 further includes a third electrode 5 (first substrate-side electrode) provided on the opposite side of the second electrode 4 from the first piezoelectric film 6, and a second piezoelectric film 7 (first lower side piezoelectric film) provided between the third electrode 5 and the second electrode 4. That is, the detecting section 2 has a bimorph structure.

The detecting section 2 and the proof mass section 8 are formed axisymmetrically with respect to the first direction (Y-axis direction).

The inertial sensor 130 further includes a side surface stopper section 10 opposed to the side surface of the proof mass section 8 and spaced by a gap (third gap 14) from the side surface of the proof mass section 8.

The first piezoelectric film 6 and the second piezoelectric film 7 are polarizable in the same direction in a plane perpendicular to the major surface 1a of the substrate 1.

This makes it possible to detect inertial effects in the third direction (Z-axis direction) perpendicular to the major surface 1a of the substrate 1 by detecting the potential difference at least one of between the first electrode 3 and the second electrode 4 and between the second electrode 4 and the third electrode 5.

More specifically, as shown in FIG. 7, when an acceleration in the Z-axis direction is applied to the inertial sensor 130, this acceleration in the Z-axis direction causes a force Fz in the Z-axis direction to act on the center of gravity 15 of the proof mass section 8, and the detecting section 2 bends in the Z-axis direction along the arrow az with reference to the support section 12h. Consequently, a compressive stress Fc in the Y-axis direction acts on the first piezoelectric film 6, and a tensile stress Ft acts on the second piezoelectric film 7. Here, by the piezoelectric effect, charges with opposite polarities occur in the Z-axis direction in the first piezoelectric film 6 and the second piezoelectric film 7. Consequently, the voltage between the second electrode 4 and the first electrode 3 is opposite in polarity to the voltage between the third electrode 5 and the second electrode 4. Then, the magnitude of the acceleration applied in the Z-axis direction can be detected by using a differential amplifier 16 to measure the potential difference between the second electrode 4 and the first electrode 3 and between the second electrode 4 and the third electrode 5.

On the other hand, when an acceleration in the X-axis direction is applied to the inertial sensor 130, a force in the X-axis direction acts on the center of gravity 15 of the proof mass section 8, and the detecting section 2 bends in the X-axis direction with reference to the support section 12h. Consequently, a compressive stress in the Y-axis direction is applied to the side surface X1 of the detecting section 2 on the positive X-axis side, and a tensile stress is applied to the side surface X2 on the negative X-axis side. This deformation is symmetric with respect to the polarity of the Z axis. Hence, the difference between the voltage generated between the second electrode 4 and the first electrode 3 and the voltage generated between the second electrode 4 and the third electrode 5 vanishes. That is, the inertial sensor 130 is not sensitive to acceleration in the X-axis direction.

On the other hand, when an acceleration in the Y-axis direction is applied to the inertial sensor 130, a tensile stress in the Y-axis direction is applied nearly evenly to the piezoelectric film of the detecting section 2 because the center of gravity 15 of the proof mass section 8 is located on the center line of the detecting section 2 and in the plane of the piezoelectric film 6. Thus, at this time, the voltage between the second electrode 4 and the first electrode 3 has the same polarity as the voltage between the third electrode 5 and the second electrode 4. Hence, when the first and third electrode 3, 5 are short-circuited to the second electrode 4, the voltage with respect to the second electrode 4 vanishes, and the inertial sensor 130 is not sensitive to acceleration in the Y-axis direction.

As shown in FIG. 6, the substrate 1 is placed on the substrate 1 side of the proof mass section 8 and the detecting section 2 via the first gap 13, the upper surface stopper section 17 is placed above the proof mass section 8 and the detecting section 2 via the second gap 18, and the side surface stopper section 10 is opposed to the side surface 8s of the proof mass section 8 via the third gap 14. Thus, the inertial sensor 130 has high strength against impact load in all directions along the X, Y, and Z axis.

More specifically, the structural strength is high in the Y-axis direction, and there is no problem with impact load applied in the Y-axis direction. When an impact load is applied in the X-axis direction, the proof mass section 8 is brought into contact with the side surface stopper section 10 and restricted in its bending deformation, which can prevent the detecting section 2 and the like from being broken by application of excessive stress. Furthermore, when an impact load is applied in the Z-axis direction, the proof mass section 8 is brought into contact with the substrate 1 or the upper surface stopper section 17 and restricted in its bending deformation, which can prevent the detecting section 2 and the like from being broken by application of excessive stress.

Thus, this embodiment can realize a uniaxial accelerometer being sensitive to acceleration in the Z-axis direction and having sufficient resistance to impact force in the X-axis, Y-axis, and Z-axis direction.

Thus, the inertial sensor 130 according to the third embodiment can provide an ultrasmall inertial sensor which is capable of high-accuracy detection without temperature compensation and easy to manufacture.

In the inertial sensor 130 according to this embodiment, as shown in FIG. 6, the proof mass section 8 is composed of a first piezoelectric layer film 6f serving as the first piezoelectric film 6, a second conductive film 4f serving as the second electrode 4, a second piezoelectric layer film 7f serving as the second piezoelectric film 7, and a third conductive film 5f (first substrate-side conductive film) serving as the third electrode 5, which are included in the detecting section 2. However, the invention is not limited thereto, but the proof mass section 8 can be formed from any material. In this regard, advantageously, the proof mass section 8 is composed of the material included in the detecting section 2 to facilitate manufacturing. That is, the proof mass section 8 can include at least one of a first conductive film 3f serving as the first electrode 3, a second conductive film 4f serving as the second electrode 4, a third conductive film 5f serving as the third electrode 5, a first piezoelectric layer film 6f serving as the first piezoelectric film 6, and a second piezoelectric layer film 7f (first lower side piezoelectric layer film) serving as the second piezoelectric film 7. That is, the proof mass section 8 can include a layer which is continuous with at least one of the first electrode 3, the second electrode 4, the third electrode 5, the first piezoelectric film 6, and the second piezoelectric film 7.

The detecting section 2 and the proof mass section 8 are formed generally coplanarly.

Furthermore, the side surface stopper section 10 is composed of the first piezoelectric layer film 6f serving as the first piezoelectric film 6, the second conductive film 4f serving as the second electrode 4, the second piezoelectric layer film 7f serving as the second piezoelectric film 7, and the third conductive film 5f serving as the third electrode 5, which are included in the detecting section 2. However, the invention is not limited thereto, but the side surface stopper section 10 can be formed from any material. In this regard, advantageously, the side surface stopper section 10 is composed of the material included in the detecting section 2 to facilitate manufacturing. That is, the side surface stopper section 10 can include at least one of a first conductive film 3f serving as the first electrode 3, a second conductive film 4f serving as the second electrode 4, a third conductive film 5f serving as the third electrode 5, a first piezoelectric layer film 6f serving as the first piezoelectric film 6, and a second piezoelectric layer film 7f serving as the second piezoelectric film 7.

### Fourth Embodiment

The first and second embodiment provide a uniaxial inertial sensor for detecting acceleration in a direction parallel to the major surface 1a of the substrate 1, and the third embodiment provides a uniaxial inertial sensor for detecting acceleration in the direction perpendicular thereto. In contrast, the inertial sensor 140 according to the fourth embodiment is an inertial sensor having biaxial sensitivity which can detect acceleration in directions parallel and perpendicular to the major surface 1a of the substrate 1.

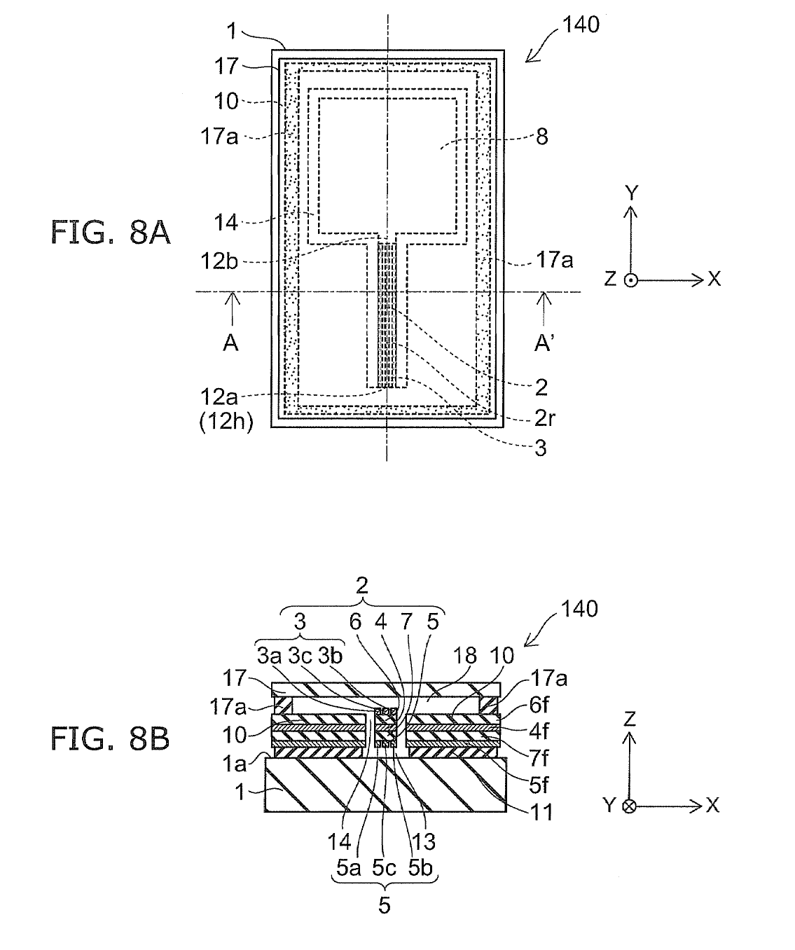

FIG. 8 is a schematic view illustrating the configuration of an inertial sensor according to a fourth embodiment of the invention.

More specifically, FIG. 8A is a schematic plan view (top view), and FIG. 8B is a cross-sectional view taken along line A-A′ in FIG. 8A.

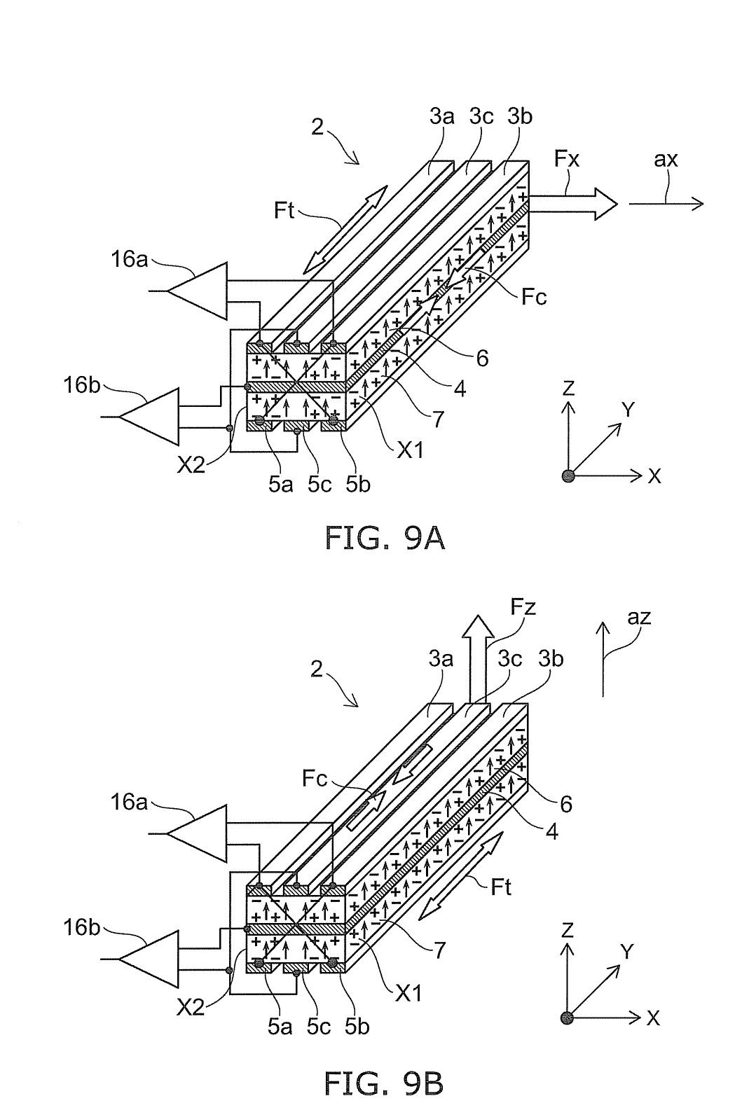

FIG. 9 is a schematic perspective view illustrating the operation of the inertial sensor according to the fourth embodiment of the invention.

As shown in FIG. 8, the inertial sensor 140 according to the fourth embodiment of the invention is different from the inertial sensor 130 according to the third embodiment in the structure of the detecting section 2. The rest of the configuration is the same as that of the inertial sensor 130, and hence the detecting section 2 is described.

In the inertial sensor 140 according to this embodiment, the detecting section 2 has a structure in which a first electrode 3, a first piezoelectric film 6, a second electrode 4, a second piezoelectric film 7, and a third electrode 5 are stacked. That is, the detecting section 2 has a bimorph structure. The first electrode 3 is split widthwise (in the direction orthogonal to the extending direction) into a first split electrode 3a, a second split electrode 3b, and a third split electrode 3c. Furthermore, the third electrode 5 is also split widthwise into a fourth split electrode 5a, a fifth split electrode 5b, and a sixth split electrode 5c. Thus, at least one of the first electrode 3 (first upper side electrode) and the third electrode 5 (first substrate-side electrode) can includes a plurality of split electrodes extending in the first direction,

As shown in FIG. 9, a first differential amplifier 16a is connected to the first split electrode 3a and the second split electrode 3b, and to the fourth split electrode 5a and the fifth split electrode 5b. On the other hand, a second differential amplifier 16b is connected to the second electrode 4, and to the third split electrode 3c and the sixth split electrode 5c.

Here, as shown in FIG. 9A, when an acceleration in the X-axis direction is applied to the inertial sensor 140, the acceleration in the X-axis direction causes a force Fx in the X-axis direction to act on the center of gravity 15 of the proof mass section 8, and the detecting section 2 bends in the X-axis direction along the arrow ax with reference to the support section 12h. Consequently, a compressive stress Fc in the Y-axis direction acts on the side surface X1 of the detecting section 2 on the positive X-axis side. On the other hand, a tensile stress Ft acts on the side surface X2 on the negative X-axis side. Here, by the piezoelectric effect, the piezoelectric film 6 is charged in the Z-axis direction. The polarity of charge is opposite between the side surface X1 on the positive X-axis side and the side surface X2 on the negative X-axis side. That is, the polarity of charge is opposite between the first split electrode 3a and the second split electrode 3b, and between the fourth split electrode 5a and the fifth split electrode 5b. The magnitude of the acceleration applied in the X-axis direction can be detected by using the first differential amplifier 16a to measure the voltage between the first split electrode 3a and the second split electrode 3b, or between the fourth split electrode 5a and the fifth split electrode 5b.

Here, because the third split electrode 3c and the sixth split electrode 5c are formed at the center of the detecting section 2, no potential difference occurs therein with respect to the second electrode 4. Hence, the second differential amplifier 16b, which is connected to the second electrode 4 and to the third split electrode 3c and the sixth split electrode 5c short-circuited with each other, is not sensitive to acceleration in the X-axis direction.

Next, as shown in FIG. 9B, when an acceleration in the Z-axis direction is applied to the inertial sensor 140, the acceleration in the Z-axis direction causes a force Fz in the Z-axis direction to act on the center of gravity 15 of the proof mass section 8, and the detecting section 2 bends in the Z-axis direction along the arrow az with reference to the support section 12h. Consequently, a compressive stress Fc in the Y-axis direction acts on the first piezoelectric film 6, and a tensile stress Ft acts on the second piezoelectric film 7. By the piezoelectric effect, charges with opposite polarities occur in the Z-axis direction in the first piezoelectric film 6 and the second piezoelectric film 7. Here, the voltage generated between the second electrode 4 and the first split electrode 3a is equal to the voltage generated between the second electrode 4 and the second split electrode 3b. Likewise, the voltage generated between the second electrode 4 and the fourth split electrode 5a is equal to the voltage generated between the second electrode 4 and the fifth split electrode 5b. Hence, the first differential amplifier 16a is not sensitive to acceleration in the Z-axis direction.

On the other hand, a voltage depending on the acceleration in the Z-axis direction occurs between the second electrode 4, and the third split electrode 3c and the sixth split electrode 5c. The magnitude of the acceleration applied in the Z-axis direction can be detected by using the second differential amplifier 16b to measure this voltage.

When an acceleration in the Y-axis direction is applied to the inertial sensor 140, a tensile stress in the Y-axis direction is applied nearly evenly to the first and second piezoelectric film 6, 7 of the detecting section 2 because the center of gravity 15 of the proof mass section 8 is located on the center line of the detecting section 2 and between the first and second piezoelectric film 6, 7. Thus, at this time, the voltage generated between the second electrode 4 and the first split electrode 3a is equal to the voltage generated between the second electrode 4 and the second split electrode 3b. Likewise, the voltage generated between the second electrode 4 and the fourth split electrode 5a is equal to the voltage generated between the second electrode 4 and the fifth split electrode 5b. Hence, the first differential amplifier 16a connected thereto is not sensitive to acceleration in the Y-axis direction.

Furthermore, the voltage between the second electrode 4 and the third split electrode 3c and the voltage between the second electrode 4 and the sixth split electrode 5c are equal in magnitude but opposite in polarity. Hence, the second differential amplifier 16b, which is connected to the second electrode 4, and to the third split electrode 3c and the sixth split electrode 5c short-circuited with each other, is not sensitive to acceleration in the Y-axis direction.

On the other hand, under application of impact load, the inertial sensor 140 provides similar performance to that of the inertial sensors 120, 130 according to the second and third embodiment described above. More specifically, the structural strength is high in the Y-axis direction, and there is no problem with impact load applied in the Y-axis direction. When an impact load is applied in the X-axis direction, the proof mass section 8 is brought into contact with the side surface stopper section 10 and restricted in its bending deformation, which can prevent the detecting section 2 and the like from being broken by application of excessive stress. Furthermore, when an impact load is applied in the Z-axis direction, the proof mass section 8 is brought into contact with the substrate 1 or the upper surface stopper section 17 and restricted in its bending deformation, which can prevent the detecting section 2 and the like from being broken by application of excessive stress.

Thus, the inertial sensor 140 according to this embodiment can realize an inertial sensor having sufficient resistance to impact force in the X-axis, Y-axis, and Z-axis direction and having biaxial detection sensitivity parallel and perpendicular to the major surface 1a of the substrate 1, in which the first differential amplifier 16a is sensitive to acceleration in the X-axis direction, and the second differential amplifier 16b is sensitive to acceleration in the Z-axis direction.

Thus, the inertial sensor 140 according to this embodiment can provide an ultrasmall inertial sensor having biaxial detection sensitivity which is capable of high-accuracy detection without temperature compensation and easy to manufacture.

### Fifth Embodiment

Like the fourth embodiment, the inertial sensor according to the fifth embodiment is an inertial sensor having biaxial sensitivity which can detect acceleration in directions parallel and perpendicular to the major surface 1a of the substrate 1.

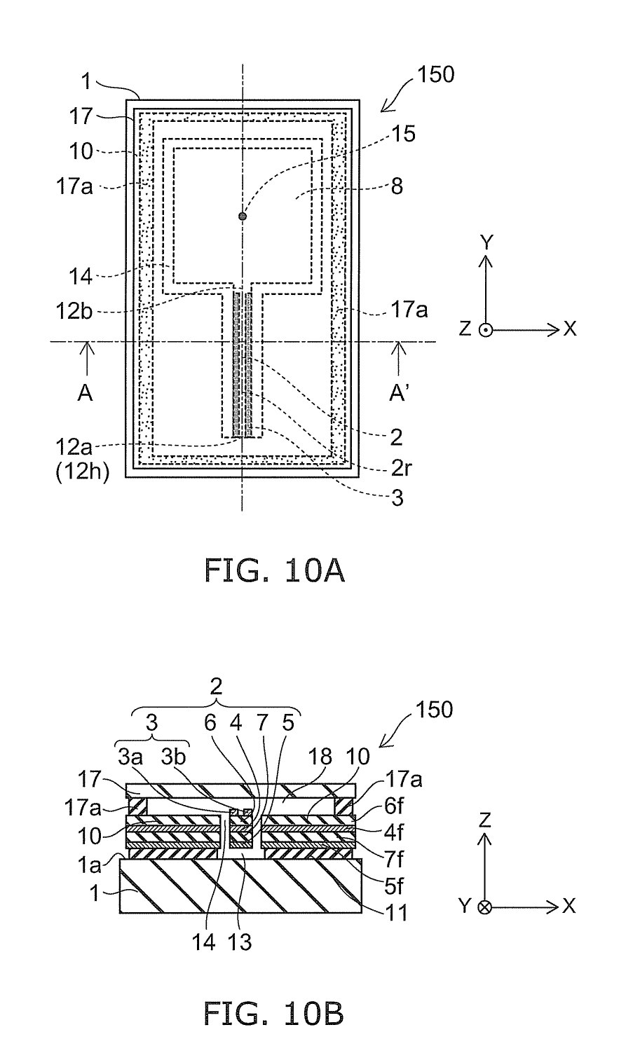

FIG. 10 is a schematic view illustrating the configuration of an inertial sensor according to a fifth embodiment of the invention. More specifically, FIG. 10A is a schematic plan view (top view), and FIG. 10B is a cross-sectional view taken along line A-A′ in FIG. 10A.

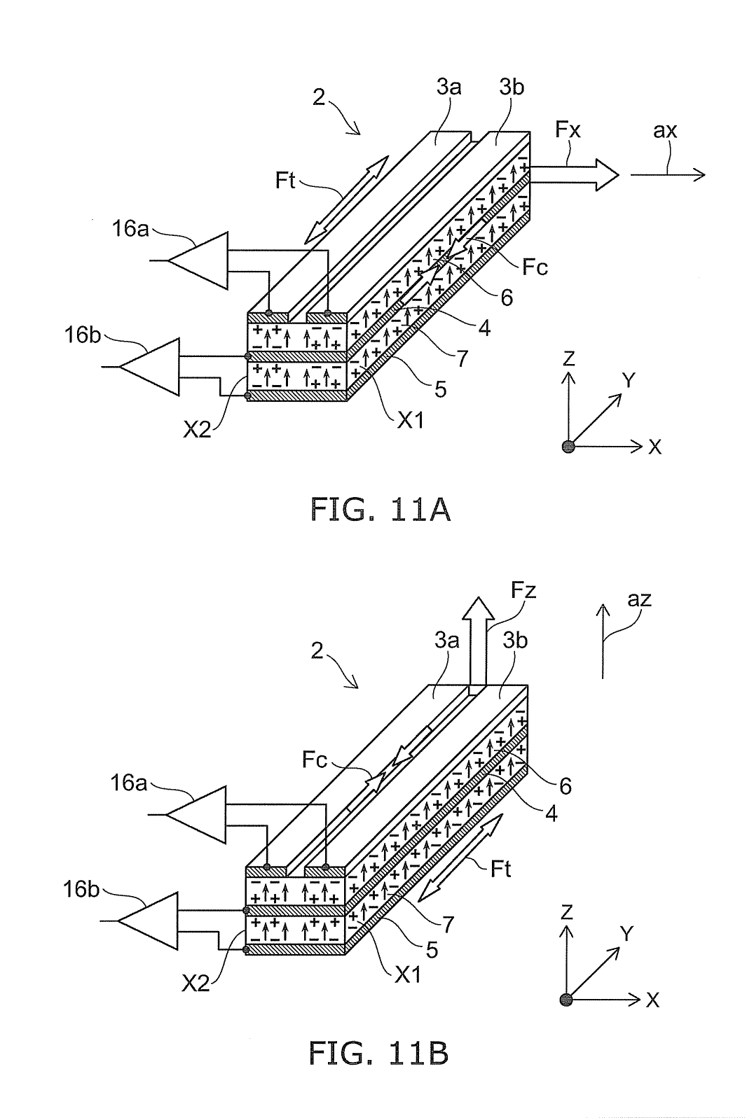

FIG. 11 is a schematic perspective view illustrating the operation of the inertial sensor according to the fifth embodiment of the invention.

As shown in FIG. 10, the inertial sensor 150 according to the fifth embodiment of the invention is different from the inertial sensor 140 according to the fourth embodiment in the structure of the detecting section 2. The rest of the configuration is the same as that of the inertial sensor 140, and hence the detecting section 2 is described.

In the inertial sensor 150 according to this embodiment, the detecting section 2 has a structure in which a first electrode 3, a first piezoelectric film 6, a second electrode 4, a second piezoelectric film 7, and a third electrode 5 are stacked. That is, the detecting section 2 has a bimorph structure. The first electrode 3 is split widthwise into a first split electrode 3a and a second split electrode 3b. However, the third electrode 5 is not split.

As shown in FIG. 11, a first differential amplifier 16a is connected to the first split electrode 3a and the second split electrode 3b. On the other hand, a second differential amplifier 16b is connected to the second electrode 4 and the third electrode 5.

Here, as shown in FIG. 11A, when an acceleration in the X-axis direction is applied to the inertial sensor 150, the acceleration in the X-axis direction causes a force Fx in the X-axis direction to act on the center of gravity 15 of the proof mass section 8, and the detecting section 2 bends in the X-axis direction along the arrow ax with reference to the support section 12h. Consequently, a compressive stress Fc in the Y-axis direction acts on the side surface X1 of the detecting section 2 on the positive X-axis side. Furthermore, a tensile stress Ft acts on the side surface X2 on the negative X-axis side. Here, by the piezoelectric effect, the first piezoelectric film 6 and the second piezoelectric film 7 are charged in the Z-axis direction. The polarity of charge is opposite between the side surface X1 on the positive X-axis side and the side surface X2 on the negative X-axis side. That is, the polarity of charge is opposite between the first split electrode 3a and the second split electrode 3b. The magnitude of the acceleration applied in the X-axis direction can be detected by using the first differential amplifier 16a to measure the voltage between the first split electrode 3a and the second split electrode 3b.

Here, because the second electrode 4 and the third electrode 5 are formed continuously in the width direction, charges induced at the side surface X1 on the positive X-axis side and at the side surface X2 on the negative X-axis side are canceled out, and no potential difference occurs between the second electrode 4 and the third electrode 5. Hence, the second differential amplifier 16b is not sensitive to acceleration in the X-axis direction.

As shown in FIG. 11B, when an acceleration in the Z-axis direction is applied to the inertial sensor 150, the acceleration in the Z-axis direction causes a force Fz in the Z-axis direction to act on the center of gravity 15 of the proof mass section 8, and the detecting section 2 bends in the Z-axis direction along the arrow az with reference to the support section 12h. Thus, a compressive stress Fc in the Y-axis direction acts on the first piezoelectric film 6, and a tensile stress Ft acts on the second piezoelectric film 7. By the piezoelectric effect, charges with opposite polarities occur in the Z-axis direction in the first piezoelectric film 6 and the second piezoelectric film 7. Here, the voltages generated in the first split electrode 3a and the second split electrode 3b are equal. Hence, the first differential amplifier 16a is not sensitive to acceleration in the Z-axis direction.

On the other hand, a voltage depending on the acceleration in the Z-axis direction occurs between the second electrode 4 and the third electrode 5. The magnitude of the acceleration applied in the Z-axis direction can be detected by using the second differential amplifier 16b to measure this voltage.

Next, when an acceleration in the Y-axis direction is applied to the inertial sensor 150, a tensile stress in the Y-axis direction is applied nearly evenly to the first and second piezoelectric film 6, 7 of the detecting section 2 because the center of gravity 15 of the proof mass section 8 is located on the center line of the detecting section 2 and between the first piezoelectric film 6 and the second piezoelectric film 7. Thus, at this time, the voltages generated in the first split electrode 3a and the second split electrode 3b are equal. Hence, the first differential amplifier 16a connected thereto is not sensitive to acceleration in the Y-axis direction.

Furthermore, the tensile stress in the Y-axis direction induces a very weak charge between the second electrode 4 and the third electrode 5, and the second differential amplifier 16b is slightly sensitive to acceleration in the Y-axis direction.

On the other hand, under application of impact load, the inertial sensor 150 provides similar performance to that of the inertial sensors 120, 130, 140 according to the second to fourth embodiment described above. More specifically, the structural strength is high in the Y-axis direction, and there is no problem with impact load applied in the Y-axis direction. When an impact load is applied in the X-axis direction, the proof mass section 8 is brought into contact with the side surface stopper section 10 and restricted in its bending deformation, which can prevent the detecting section 2 and the like from being broken by application of excessive stress. Furthermore, when an impact load is applied in the Z-axis direction, the proof mass section 8 is brought into contact with the substrate 1 or the upper surface stopper section 17 and restricted in its bending deformation, which can prevent the detecting section 2 and the like from being broken by application of excessive stress.

Thus, in the inertial sensor 150 according to this embodiment, the first differential amplifier 16a is sensitive to acceleration in the X-axis direction, and the second differential amplifier 16b has high sensitivity to acceleration in the Z-axis direction, and slight sensitivity to acceleration in the Y-axis direction. Furthermore, the inertial sensor 150 has sufficient resistance to impact force in the X-axis, Y-axis, and Z-axis direction.

Thus, the inertial sensor 150 according to this embodiment can provide an ultrasmall inertial sensor having biaxial detection sensitivity which is capable of high-accuracy detection without temperature compensation and easy to manufacture.

In some applications, the inertial sensor 150 according to this embodiment can be used as a stand-alone inertial sensor. However, as described below, two copies of the inertial sensor can be combined to serve as a triaxial inertial sensor.

### Sixth Embodiment

The inertial sensor according to the sixth embodiment of the invention is an inertial sensor having biaxial sensitivity with the detection axes arranged perpendicular to each other in the major surface 1a of the substrate 1, using two copies of the inertial sensor 121 described in the first practical example according to the second embodiment. This embodiment makes use of MEMS (microelectromechanical system) technology, which is characterized in that it can simultaneously fabricate a plurality of elements in the same process and accurately place a plurality of elements at arbitrary positions.

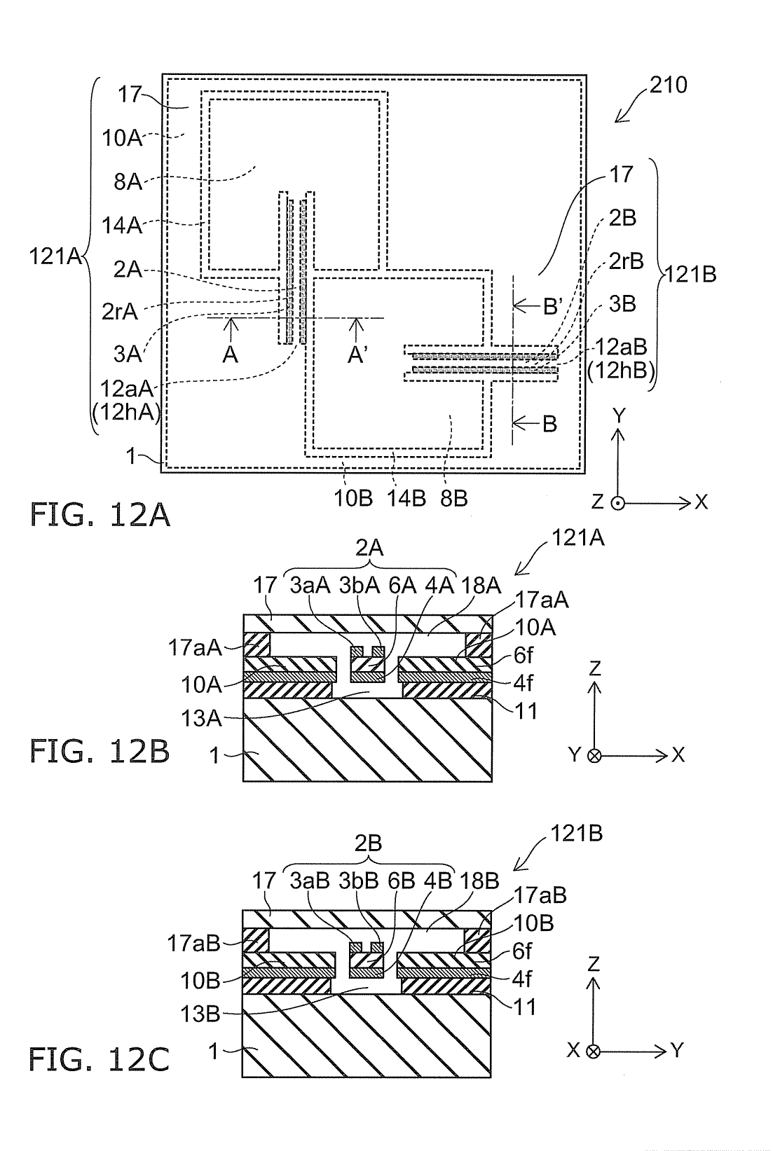

FIG. 12 is a schematic view illustrating the configuration of an inertial sensor according to a sixth embodiment of the invention. More specifically, FIG. 12A is a schematic plan view (top view), FIG. 12B is a cross-sectional view taken along line A-A′ in FIG. 12A, and FIG. 12C is a cross-sectional view taken along line B-B′ in FIG. 12A.

As shown in FIG. 12, the inertial sensor 210 according to the sixth embodiment of the invention includes a first inertial sensor 121A and a second inertial sensor 121B.

The first inertial sensor 121A includes a beam 2rA (first beam) having a detecting section 2A (first detecting section), a proof mass section 8A (first proof mass section), a side surface stopper section 10A (first side surface stopper section), and an upper surface stopper section 17 (first upper surface stopper section).

One end 12aA of the beam 2rA is connected to a major surface 1a of a substrate 1.

The other end 12bA of the beam 2rA (detecting section 2A) is connected to the proof mass section 8A. The one end 12aA of the beam 2rA is identical to the support section 12hA of the detecting section 2A.

The detecting section 2A includes a first electrode 3A (first upper side electrode), a second electrode 4A (first lower side electrode), and a first piezoelectric film 6A (first upper side piezoelectric film) provided between the first electrode 3A and the second electrode 4A, and extends in the first direction (Y-axis direction) in a plane parallel to the major surface 1a of the substrate 1.

The proof mass section 8A is composed of a first piezoelectric layer film 6f (first upper side piezoelectric layer film) serving as the first piezoelectric film 6A, and a second conductive film 4f (first lower side conductive film) serving as the second electrode 4A.

The side surface stopper section 10A is composed of the first piezoelectric layer film 6f serving as the first piezoelectric film 6A, and the second conductive film 4f serving as the second electrode 4A, and is opposed to the side surface 8sA of the proof mass section 8A and spaced by a third gap 14A.

The upper surface stopper section 17 is provided on the opposite side of the proof mass section 8A and the detecting section 2A from the substrate 1 and spaced by a second gap 18A.

The first piezoelectric film 6A is polarized in the direction (Z-axis direction) perpendicular to the major surface 1a of the substrate 1.

The second inertial sensor 121B includes a beam 2rB (second beam) having a detecting section 2B (second detecting section), a proof mass section 8B (second proof mass section), a side surface stopper section 10B (second side surface stopper section), and an upper surface stopper section 17 (second upper surface stopper section).

One end 12aB of the beam 2rB is connected to the major surface 1a of the substrate 1.

The other end 12bB of the beam 2rB (detecting section 2B) is connected to the proof mass section 8B. The one end 12aB of the beam 2rB is identical to the support section 12hB of the detecting section 2B.

The detecting section 2B includes a first electrode 3B (second upper side electrode), a second electrode 4B (second lower side electrode), and a first piezoelectric film 6B (second upper side piezoelectric film) provided between the first electrode 3B and the second electrode 4B, and extends in the direction (X-axis direction) parallel to the major surface 1a of the substrate 1 and perpendicular to the first direction (Y-axis direction).

The proof mass section 8B is composed of the first piezoelectric layer film 6f (second upper side piezoelectric layer film) serving as the first piezoelectric film 6B, and the second conductive film 4f (second lower side conductive film) serving as the second electrode 4B.

The side surface stopper section 10B is composed of the first piezoelectric layer film 6f serving as the first piezoelectric film 6B, and the second conductive film 4f serving as the second electrode 4B, and is opposed to the side surface 8sB of the proof mass section 8B and spaced by a third gap 14B.

The upper surface stopper section 17 is provided on the opposite side of the proof mass section 8B and the detecting section 2B from the substrate 1 and spaced by a second gap 18B. In the first inertial sensor 121A and the second inertial sensor 121B, the upper surface stopper section 17 (first upper surface stopper section and second upper surface stopper section) is made of the same material.

The first piezoelectric film 6B is polarized in the direction (Z-axis direction) perpendicular to the major surface 1a of the substrate 1.

As described above, the second conductive film 4f serving as the second electrode 4A and the first piezoelectric layer film 6f serving as the first piezoelectric film 6A in the detecting section 2A, the proof mass section 8A, and the side surface stopper section 10A of the first inertial sensor 121A are respectively made of the same films as the second conductive film 4f serving as the second electrode 4B and the first piezoelectric layer film 6f serving as the first piezoelectric film 6B in the detecting section 2B, the proof mass section 8B, and the side surface stopper section 10B of the second inertial sensor 121B.

The structure and operation of the first and second inertial sensor 121A, 121B are described in detail in the first practical example, and hence are not repeated here.

As is clear from FIG. 12, in the first inertial sensor 121A, the detecting section 2A extends in the Y-axis direction and is sensitive to only the acceleration in the X-axis direction. In the second inertial sensor 121B, the detecting section 2B extends in the X-axis direction and is sensitive to only the acceleration in the Y-axis direction. These first and second inertial sensor 121A, 121B can be placed accurately in the substrate by a single process.

Hence, an output corresponding to acceleration in the X-axis direction can be obtained by a first differential amplifier (not shown) connected to the first split electrode 3aA and the second split electrode 3bA of the first inertial sensor 121A. On the other hand, an output corresponding to acceleration in the Y-axis direction can be obtained by a second differential amplifier (not shown) connected to the first split electrode 3aB and the second split electrode 3bB of the second inertial sensor 121B. Thus, the inertial sensor 210 according to this embodiment can provide an inertial sensor having biaxial sensitivity in the X-axis and Y-axis direction.

Thus, the inertial sensor 210 according to this embodiment can provide an ultrasmall inertial sensor having biaxial detection sensitivity which is capable of high-accuracy detection without temperature compensation and easy to manufacture.

### Seventh Embodiment

The inertial sensor according to the seventh embodiment of the invention is a biaxial inertial sensor having detection axes in one direction in the substrate plane and in the direction perpendicular to the substrate, using an inertial sensor of a variation of the inertial sensor 121 described in the first practical example according to the second embodiment and the inertial sensor 130 according to the third embodiment. This embodiment also makes use of MEMS technology, which is characterized in that it can simultaneously fabricate a plurality of elements in the same process and accurately place a plurality of elements at arbitrary positions.

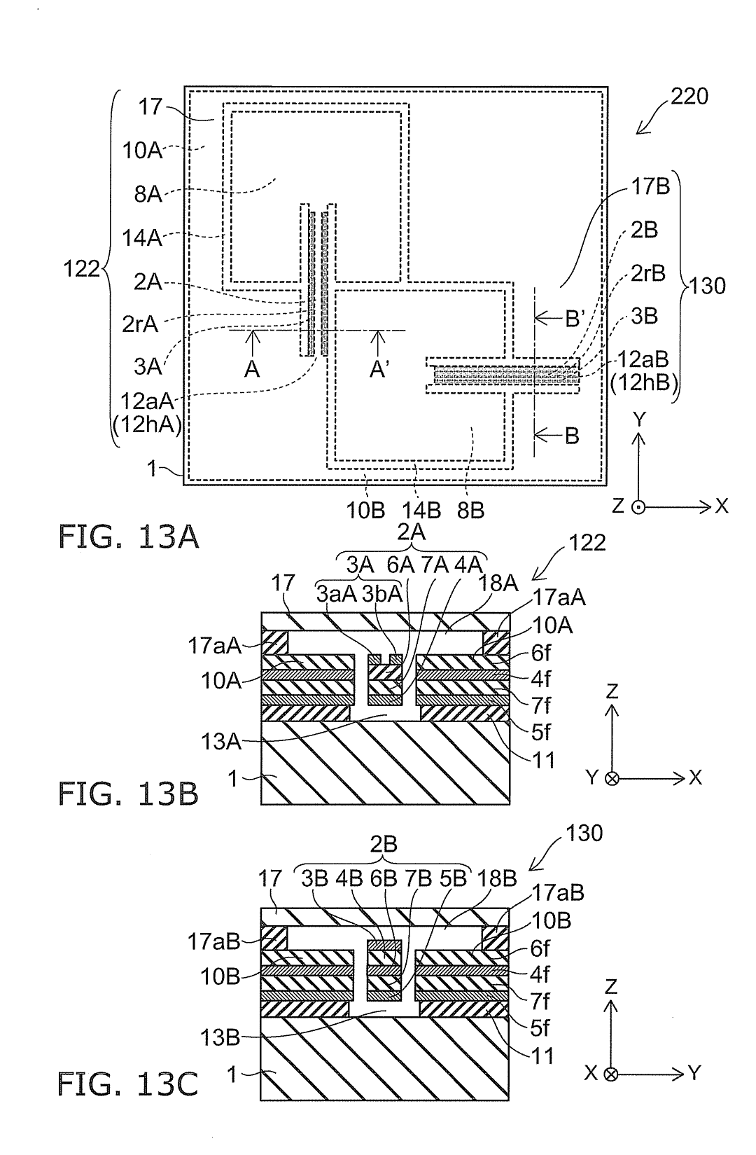

FIG. 13 is a schematic view illustrating the configuration of an inertial sensor according to a seventh embodiment of the invention. More specifically, FIG. 13A is a schematic plan view (top view), FIG. 13B is a cross-sectional view taken along line A-A′ in FIG. 13A, and FIG. 13C is a cross-sectional view taken along line B-B′ in FIG. 13A.

As shown in FIG. 13, the inertial sensor 220 according to the seventh embodiment of the invention includes a first inertial sensor 122 and a second inertial sensor 130.

The first inertial sensor 122 includes a beam 2rA having a detecting section 2A, a proof mass section 8A, a side surface stopper section 10A, and an upper surface stopper section 17.

One end 12aA of the beam 2rA is connected to a major surface 1a of a substrate 1.

The other end 12bA of the beam 2rA (detecting section 2A) is connected to the proof mass section 8A. The one end 12aA of the beam 2rA is identical to the support section 12hA of the detecting section 2A.

The detecting section 2A includes a first electrode 3A, a second electrode 4A, and a first piezoelectric film 6A and a second piezoelectric film 7A provided between the first electrode 3A and the second electrode 4A, and extends in the first direction (Y-axis direction) in a plane parallel to the major surface 1a of the substrate 1.

Here, in the detecting section 2A, the first electrode 3A is made of a first conductive film 3f, the second electrode 4A is made of a third conductive film 5f (film serving as at least one of first lower side conductive film and first substrate-side conductive film), the first piezoelectric film 6A is made of a first piezoelectric layer film 6f, and the second piezoelectric film 7A is made of a second piezoelectric layer film 7f.

The proof mass section 8A is composed of a first piezoelectric layer film 6f, a second conductive film 4f, a second piezoelectric layer film 7f, and a third conductive film 5f.

The side surface stopper section 10A is composed of the first piezoelectric layer film 6f, the second conductive film 4f, the second piezoelectric layer film 7f, and the third conductive film 5f, and is opposed to the side surface 8sA of the proof mass section 8A and spaced by a third gap 14A.

The upper surface stopper section 17 is provided on the opposite side of the proof mass section 8A and the detecting section 2A from the substrate 1 and spaced by a second gap 18A.

The first piezoelectric film 6A is polarized in the direction (Z-axis direction) perpendicular to the major surface 1a of the substrate 1.

The first electrode 3A is bisected widthwise into a first split electrode 3aA and a second split electrode 3bA.

That is, the first inertial sensor 122 has a structure which is different from that of the inertial sensor 121 according to the first practical example in that the third electrode is not provided and a first piezoelectric film 6 and a second piezoelectric film 7 are provided between the first electrode 3 and the second electrode 4. In the first inertial sensor 122 of the inertial sensor 220 according to this embodiment, the second electrode 4A is illustratively made of the third conductive film 5f.

On the other hand, the second inertial sensor 130 includes a beam 2rB having a detecting section 2B, a proof mass section 8B, a side surface stopper section 10B, and an upper surface stopper section 17.

One end 12aB of the beam 2rB is connected to the major surface 1a of the substrate 1.

The other end 12bB of the beam 2rB (detecting section 2B) is connected to the proof mass section 8B. The one end 12aB of the beam 2rB is identical to the support section 12hB of the detecting section 2B.

The detecting section 2B includes a first electrode 3B, a second electrode 4B, a first piezoelectric film 6B provided between the first electrode 3B and the second electrode 4B, a third electrode 5B (second substrate-side electrode) provided on the opposite side of the second electrode 4B from the first electrode 3B, and a second piezoelectric film 7B (second lower side piezoelectric film) provided between the second electrode 4B and the third electrode 5B, and extends in the direction (X-axis direction) parallel to the major surface 1a of the substrate 1 and perpendicular to the first direction (Y-axis direction).

The proof mass section 8B is composed of the first piezoelectric layer film 6f serving as the first piezoelectric film 6B, the second conductive film 4f serving as the second electrode 4B, the second piezoelectric layer film 7f (second lower side piezoelectric layer film) serving as the second piezoelectric film 7B, and the third conductive film 5f (second substrate-side conductive film) serving as the third electrode 5B.

The side surface stopper section 10B is composed of the first piezoelectric layer film 6f serving as the first piezoelectric film 6B, the second conductive film 4f serving as the second electrode 4B, the second piezoelectric layer film 7f serving as the second piezoelectric film 7B, and the third conductive film 5f serving as the third electrode 5B, and is opposed to the side surface 8sB of the proof mass section 8B and spaced by a third gap 14B.

The upper surface stopper section 17 is provided on the opposite side of the proof mass section 8B and the detecting section 2B from the substrate 1 and spaced by a second gap 18B. In the first inertial sensor 122 and the second inertial sensor 130, the upper surface stopper section 17 (first upper surface stopper section and second upper surface stopper section) is made of the same material.

The first piezoelectric film 6B is polarized in the direction (Z-axis direction) perpendicular to the major surface 1a of the substrate 1.

The first conductive film 3f serving as the first electrode 3A, the third conductive film 5f serving as the second electrode 4A, the first piezoelectric layer film 6f serving as the first piezoelectric film 6A, and the second piezoelectric layer film 7f serving as the second piezoelectric film 7A in the detecting section 2A of the first inertial sensor 122 are respectively made of the same films as the first conductive film 3f serving as the first electrode 3B, the third conductive film 5f serving as the third electrode 5B, the first piezoelectric layer film 6f serving as the first piezoelectric film 6B, and the second piezoelectric layer film 7f serving as the second piezoelectric film 7B in the detecting section 2B of the second inertial sensor 130.

Furthermore, the second conductive film 4f, the third conductive film 5f, the first piezoelectric layer film 6f, and the second piezoelectric layer film 7f in the proof mass section 8A and the side surface stopper section 10A of the first inertial sensor 122 are respectively made of the same films as the second conductive film 4f, the third conductive film 5f, the first piezoelectric layer film 6f, and the second piezoelectric layer film 7f in the proof mass section 8B and the side surface stopper section 10B of the second inertial sensor 130.

The structure and operation of the first and second inertial sensor 122, 130 are similar to those described in detail in the first and third embodiment, and hence are not repeated here.

In the first inertial sensor 122, the detecting section 2A extends in the Y-axis direction and is sensitive to only the acceleration in the X-axis direction. In the second inertial sensor 130, the detecting section 2B extends in the X-axis direction and is sensitive to only the acceleration in the Z-axis direction.

These first and second inertial sensor 122, 130 can be placed accurately in the same substrate by a single process.

Hence, an output corresponding to acceleration in the X-axis direction can be obtained by a first differential amplifier (not shown) connected to the first split electrode 3aA and the second split electrode 3bA of the first inertial sensor 122. On the other hand, an output corresponding to acceleration in the Z-axis direction can be obtained by a second differential amplifier (not shown) connected to the first electrode 3B and the third electrode 5B of the second inertial sensor 130. Thus, the inertial sensor 220 according to this embodiment can provide an inertial sensor having biaxial sensitivity in the X-axis and Z-axis direction.

Thus, the inertial sensor 220 according to this embodiment can provide an ultrasmall inertial sensor having biaxial detection sensitivity which is capable of high-accuracy detection without temperature compensation and easy to manufacture.

### Eighth Embodiment

The inertial sensor according to the eighth embodiment of the invention is a triaxial inertial sensor having detection axes in two orthogonal directions in the substrate plane and in the direction perpendicular to the substrate, using an inertial sensor of a variation of the inertial sensor 121 described in the first practical example according to the second embodiment and the biaxial inertial sensor 140 according to the fourth embodiment. This embodiment also makes use of MEMS technology, which is characterized in that it can simultaneously fabricate a plurality of elements in the same process and accurately place a plurality of elements at arbitrary positions.

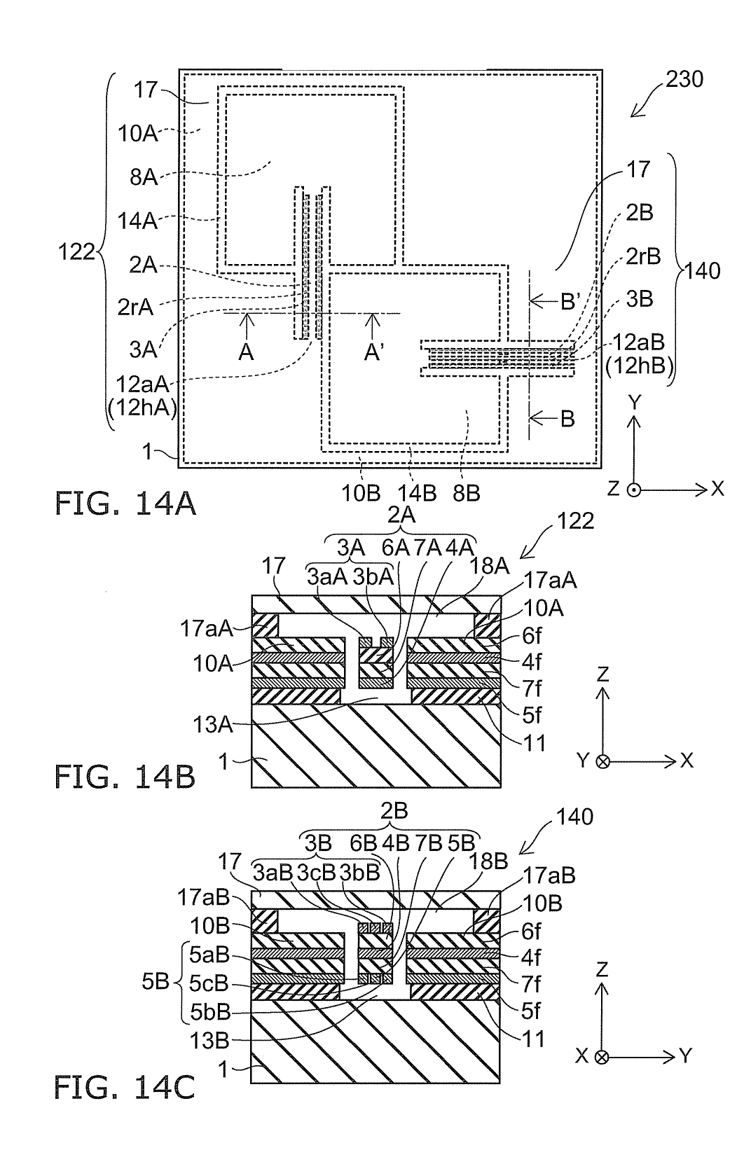

FIG. 14 is a schematic view illustrating the configuration of an inertial sensor according to an eighth embodiment of the invention. More specifically, FIG. 14A is a schematic plan view (top view), FIG. 14B is a cross-sectional view taken along line A-A′ in FIG. 14A, and FIG. 14C is a cross-sectional view taken along line B-B′ in FIG. 14A.

As shown in FIG. 14, the inertial sensor 230 according to the eighth embodiment of the invention includes a first inertial sensor 122 and a second inertial sensor 140.

The first inertial sensor 122 includes a beam 2rA having a detecting section 2A, a proof mass section 8A, a side surface stopper section 10A, and an upper surface stopper section 17.

One end 12aA of the beam 2rA is connected to a major surface 1a of a substrate 1.

The other end 12bA of the beam 2rA (detecting section 2A) is connected to the proof mass section 8A. The one end 12aA of the beam 2rA is identical to the support section 12hA of the detecting section 2A.

The detecting section 2A includes a first electrode 3A, a second electrode 4A, and a first piezoelectric film 6A and a second piezoelectric film 7A provided between the first electrode 3A and the second electrode 4A, and extends in the first direction (Y-axis direction) in a plane parallel to the major surface 1a of the substrate 1.

Here, in the detecting section 2A, the first electrode 3A is made of a first conductive film 3f, the second electrode 4A is made of a third conductive film 5f (film serving as at least one of first lower side conductive film and first substrate-side conductive film), the first piezoelectric film 6A is made of a first piezoelectric layer film 6f, and the second piezoelectric film 7A is made of a second piezoelectric layer film 7f.

The proof mass section 8A is composed of a first piezoelectric layer film 6f, a second conductive film 4f, a second piezoelectric layer film 7f, and a third conductive film 5f.

The side surface stopper section 10A is composed of the first piezoelectric layer film 6f, the second conductive film 4f, the second piezoelectric layer film 7f, and the third conductive film 5f, and is opposed to the side surface 8sA of the proof mass section 8A and spaced by a third gap 14A.

The upper surface stopper section 17 is provided on the opposite side of the proof mass section 8A and the detecting section 2A from the substrate 1 and spaced by a second gap 18A.

The first piezoelectric film 6A is polarized in the direction (Z-axis direction) perpendicular to the major surface 1a of the substrate 1.

The first electrode 3A is bisected widthwise into a first split electrode 3aA and a second split electrode 3bA.

That is, the first inertial sensor 122 has a structure which is different from that of the inertial sensor 121 according to the first practical example in that the third electrode is not provided and a first piezoelectric film 6 and a second piezoelectric film 7 are provided between the first electrode 3 and the second electrode 4. In the first inertial sensor 122 of the inertial sensor 230 according to this embodiment, the second electrode 4A is illustratively made of the third conductive film 5f.

On the other hand, the second inertial sensor 140 includes a beam 2rB having a detecting section 2B, a proof mass section 8B, a side surface stopper section 10B, and an upper surface stopper section 17.

One end 12aB of the beam 2rB is connected to the major surface 1a of the substrate 1.

The other end 12bB of the beam 2rB (detecting section 2B) is connected to the proof mass section 8B. The one end 12aB of the beam 2rB is identical to the support section 12hB of the detecting section 2B.

The detecting section 2B includes a first electrode 3B, a second electrode 4B, a first piezoelectric film 6B provided between the first electrode 3B and the second electrode 4B, a third electrode 5B provided on the opposite side of the second electrode 4B from the first electrode 3B, and a second piezoelectric film 7B provided between the second electrode 4B and the third electrode 5B, and extends in the direction (X-axis direction) parallel to the major surface 1a of the substrate 1 and perpendicular to the first direction (Y-axis direction).

The proof mass section 8B is composed of the first piezoelectric layer film 6f serving as the first piezoelectric film 6B, the second conductive film 4f serving as the second electrode 4B, the second piezoelectric layer film 7f serving as the second piezoelectric film 7B, and the third conductive film 5f serving as the third electrode 5B.

The side surface stopper section 10B is composed of the first piezoelectric layer film 6f serving as the first piezoelectric film 6B, the second conductive film 4f serving as the second electrode 4B, the second piezoelectric layer film 7f serving as the second piezoelectric film 7B, and the third conductive film 5f serving as the third electrode 5B, and is opposed to the side surface 8sB of the proof mass section 8B and spaced by a third gap 14B.

The upper surface stopper section 17 is provided on the opposite side of the proof mass section 8B and the detecting section 2B from the substrate 1 and spaced by a second gap 18B. In the first inertial sensor 122 and the second inertial sensor 140, the upper surface stopper section 17 is made of the same material.

The first piezoelectric film 6B is polarized in the direction (Z-axis direction) perpendicular to the major surface 1a of the substrate 1.

The first electrode 3B is trisected widthwise into a first to third split electrode 3aB, 3bB, 3cB, and the third electrode 5B is trisected widthwise into a fourth to sixth split electrode 5aB, 5bB, 5cB.

The first conductive film 3f serving as the first electrode 3A, the third conductive film 5f serving as the second electrode 4A, the first piezoelectric layer film 6f serving as the first piezoelectric film 6A, and the second piezoelectric layer film 7f serving as the second piezoelectric film 7A in the detecting section 2A of the first inertial sensor 122 are respectively made of the same films as the first conductive film 3f serving as the first electrode 3B, the third conductive film 5f serving as the third electrode 5B, the first piezoelectric layer film 6f serving as the first piezoelectric film 6B, and the second piezoelectric layer film 7f serving as the second piezoelectric film 7B in the detecting section 2B of the second inertial sensor 140.

Furthermore, the second conductive film 4f, the third conductive film 5f, the first piezoelectric layer film 6f, and the second piezoelectric layer film 7f in the proof mass section 8A and the side surface stopper section 10A of the first inertial sensor 122 are respectively made of the same films as the second conductive film 4f serving as the second electrode 4B, the third conductive film 5f serving as the third electrode 5B, the first piezoelectric layer film 6f serving as the first piezoelectric film 6B, and the second piezoelectric layer film 7f serving as the second piezoelectric film 7B in the proof mass section 8B and the side surface stopper section 10B of the second inertial sensor 140.

The structure and operation of the first and second inertial sensor 122, 140 are similar to those described in detail in the first and fourth embodiment, and hence are not repeated here.

In the first inertial sensor 122, the detecting section 2A extends in the Y-axis direction and is sensitive to only the acceleration in the X-axis direction. In the second inertial sensor 140, the detecting section 2B extends in the X-axis direction and is sensitive to acceleration in the Y-axis and Z-axis direction.

These first and second inertial sensor 122, 140 can be placed accurately in the same substrate by a single process.

Hence, an output corresponding to acceleration in the X-axis direction can be obtained by a first differential amplifier (not shown) connected to the first split electrode 3aA and the second split electrode 3bA of the first inertial sensor 122.

On the other hand, an output corresponding to acceleration in the Y-axis direction can be obtained by a second differential amplifier (not shown) connected to the first split electrode 3aB and the fifth split electrode 5bB short-circuited with each other, and the second split electrode 3bB and the fourth split electrode 5aB short-circuited with each other, of the second inertial sensor 140.

Furthermore, an output corresponding to acceleration in the Z-axis direction can be obtained by a third differential amplifier (not shown) connected to the second electrode 4B, and to the third split electrode 3cB and the sixth split electrode 5cB short-circuited with each other, of the second inertial sensor 140.

Thus, the inertial sensor 230 according to this embodiment can realize a triaxial inertial sensor for three independent directions orthogonal to each other.

Thus, the inertial sensor 230 according to this embodiment can provide an ultrasmall inertial sensor having triaxial detection sensitivity which is capable of high-accuracy detection without temperature compensation and easy to manufacture.

### Ninth Embodiment

The inertial sensor according to the ninth embodiment of the invention is a triaxial inertial sensor having detection axes in two orthogonal directions in the substrate plane and in the direction perpendicular to the substrate, using two copies of the biaxial inertial sensor 150 according to the fifth embodiment. This embodiment also makes use of MEMS technology, which is characterized in that it can simultaneously fabricate a plurality of elements in the same process and accurately place a plurality of elements at arbitrary positions.

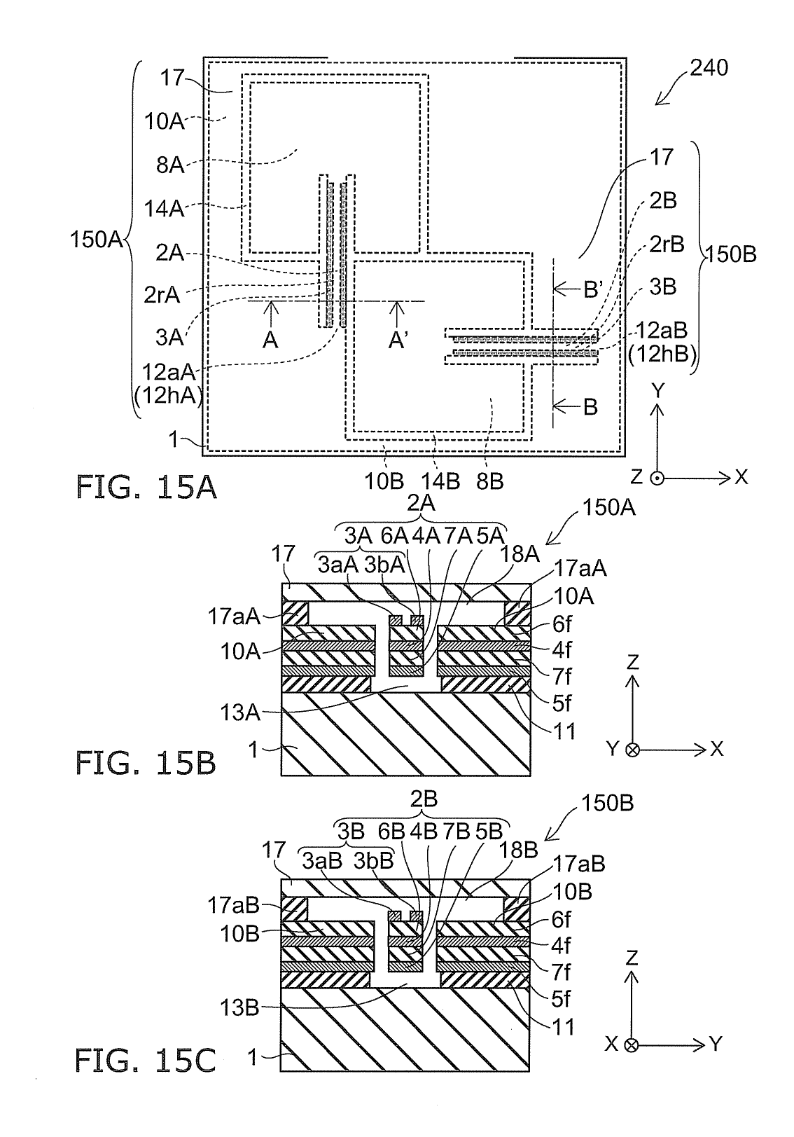

FIG. 15 is a schematic view illustrating the configuration of an inertial sensor according to a ninth embodiment of the invention. More specifically, FIG. 15A is a schematic plan view (top view), FIG. 15B is a cross-sectional view taken along line A-A′ in FIG. 15A, and FIG. 15C is a cross-sectional view taken along line B-B′ in FIG. 15A.

As shown in FIG. 15, the inertial sensor 240 according to the ninth embodiment of the invention includes a first inertial sensor 150A and a second inertial sensor 150B.

The first inertial sensor 150A includes a beam 2rA having a detecting section 2A, a proof mass section 8A, a side surface stopper section 10A, and an upper surface stopper section 17.

One end 12aA of the beam 2rA is connected to a major surface 1a of a substrate 1.

The other end 12bA of the beam 2rA (detecting section 2A) is connected to the proof mass section 8A. The one end 12aA of the beam 2rA is identical to the support section 12hA of the detecting section 2A.

The detecting section 2A includes a first electrode 3A, a second electrode 4A, a first piezoelectric film 6A provided between the first electrode 3A and the second electrode 4A, a third electrode 5A provided on the opposite side of the second electrode 4A from the first electrode 3A, and a second piezoelectric film 7A provided between the second electrode 4A and the third electrode 5A, and extends in the first direction (Y-axis direction) in a plane parallel to the major surface 1a of the substrate 1.

The proof mass section 8A is composed of a first piezoelectric layer film 6f serving as the first piezoelectric film 6A, a second conductive film 4f serving as the second electrode 4A, a second piezoelectric layer film 7f serving as the second piezoelectric film 7A, and a third conductive film 5f serving as the third electrode 5A.

The side surface stopper section 10A is composed of the first piezoelectric layer film 6f serving as the first piezoelectric film 6A, the second conductive film 4f serving as the second electrode 4A, the second piezoelectric layer film 7f serving as the second piezoelectric film 7A, and the third conductive film 5f serving as the third electrode 5A, and is opposed to the side surface 8sA of the proof mass section 8A and spaced by a third gap 14A.

The upper surface stopper section 17 is provided on the opposite side of the proof mass section 8A and the detecting section 2A from the substrate 1 and spaced by a second gap 18A.

The first piezoelectric film 6A is polarized in the direction (Z-axis direction) perpendicular to the major surface 1a of the substrate 1.

The first electrode 3A is bisected widthwise into a first split electrode 3aA and a second split electrode 3bA.

On the other hand, the second inertial sensor 150B includes a beam 2rB having a detecting section 2B, a proof mass section 8B, a side surface stopper section 10B, and an upper surface stopper section 17.

One end 12aB of the beam 2rB is connected to the major surface 1a of the substrate 1.

The other end 12bB of the beam 2rB (detecting section 2B) is connected to the proof mass section 8B. The one end 12aB of the beam 2rB is identical to the support section 12hB of the detecting section 2B.

The detecting section 2B includes a first electrode 3B, a second electrode 4B, a first piezoelectric film 6B provided between the first electrode 3B and the second electrode 4B, a third electrode 5B provided on the opposite side of the second electrode 4B from the first electrode 3B, and a second piezoelectric film 7B provided between the second electrode 4B and the third electrode 5B, and extends in the direction (X-axis direction) parallel to the major surface 1a of the substrate 1 and perpendicular to the first direction (Y-axis direction).

The proof mass section 8B is composed of the first piezoelectric layer film 6f serving as the first piezoelectric film 6B, the second conductive film 4f serving as the second electrode 4B, the second piezoelectric layer film 7f serving as the second piezoelectric film 7B, and the third conductive film 5f serving as the third electrode 5B.

The side surface stopper section 10B is composed of the first piezoelectric layer film 6f serving as the first piezoelectric film 6B, the second conductive film 4f serving as the second electrode 4B, the second piezoelectric layer film 7f serving as the second piezoelectric film 7B, and the third conductive film 5f serving as the third electrode 5B, and is opposed to the side surface 8sB of the proof mass section 8B and spaced by a third gap 14B.

The upper surface stopper section 17 is provided on the opposite side of the proof mass section 8B and the detecting section 2B from the substrate 1 and spaced by a second gap 18B. In the first inertial sensor 150A and the second inertial sensor 150B, the upper surface stopper section 17 is made of the same material.

The first piezoelectric film 6B is polarized in the direction (Z-axis direction) perpendicular to the major surface 1a of the substrate 1.

The first electrode 3B is bisected widthwise into a first split electrode 3aB and a second split electrode 3bB.

The structure and operation of the first and second inertial sensor 150A, 150B are described in detail in the fifth embodiment, and hence are not repeated here.

A first differential amplifier (not shown, output V1) connected to the first and second split electrode 3aA, 3bA of the first inertial sensor 150A has a sensitivity coefficient a for only the acceleration in the X-axis direction. On the other hand, a second differential amplifier (not shown, output V2) connected to the second electrode 4A and the third electrode 5A of the first inertial sensor 150A has a sensitivity coefficient b for acceleration in the Z-axis direction and a sensitivity coefficient c for acceleration in the Y-axis direction. Here, b is several times or more larger than c.

Likewise, a third differential amplifier (not shown, output V3) connected to the first and second split electrode 3aB, 3bB of the second inertial sensor 150B has a sensitivity coefficient a for only the acceleration in the Y-axis direction. On the other hand, a fourth differential amplifier (not shown, output V4) connected to the second electrode 4B and the third electrode 5B of the second inertial sensor 150B has a sensitivity coefficient b for acceleration in the Z-axis direction and a sensitivity coefficient c for acceleration in the X-axis direction.

Hence, denoting by Ax, Ay, Az the acceleration in the X-axis, Y-axis, Z-axis direction, respectively, each acceleration is given by the following formula from the output of the differential amplifiers:

Ax=V1/a

Ay=V2/a

Az=(V2+V4)/2b−(V1+V3)c/a (1)

Thus, the inertial sensor 240 according to this embodiment can realize a triaxial inertial sensor for three independent directions orthogonal to each other.

Thus, the inertial sensor 240 according to this embodiment can provide an ultrasmall inertial sensor having triaxial detection sensitivity which is capable of high-accuracy detection without temperature compensation and easy to manufacture.

### Tenth Embodiment

The inertial sensor according to the tenth embodiment of the invention is a triaxial inertial sensor having detection axes in two orthogonal directions in the substrate plane and in the direction perpendicular to the substrate, using two copies of an inertial sensor of a variation of the inertial sensor 121 described in the first practical example according to the second embodiment and the inertial sensor 130 according to the third embodiment. This embodiment also makes use of MEMS technology, which is characterized in that it can simultaneously fabricate a plurality of elements in the same process and accurately place a plurality of elements at arbitrary positions.

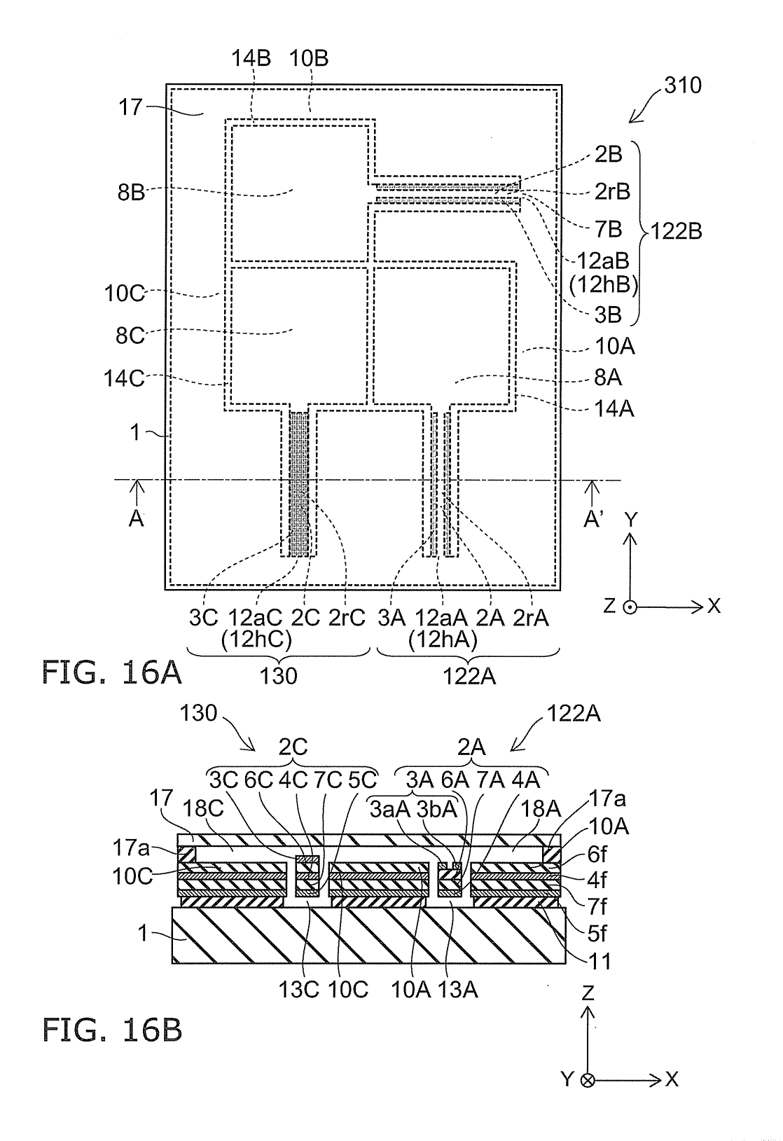

FIG. 16 is a schematic view illustrating the configuration of an inertial sensor according to a tenth embodiment of the invention.

More specifically, FIG. 16A is a schematic plan view (top view), and FIG. 16B is a cross-sectional view taken along line A-A′ in FIG. 16A.

As shown in FIG. 16, the inertial sensor 310 according to the tenth embodiment of the invention includes a first inertial sensor 122A, a second inertial sensor 122B, and a third inertial sensor 130.

The first inertial sensor 122A includes a beam 2rA having a detecting section 2A, a proof mass section 8A, a side surface stopper section 10A, and an upper surface stopper section 17.

One end 12aA of the beam 2rA is connected to a major surface 1a of a substrate 1.

The other end 12bA of the beam 2rA (detecting section 2A) is connected to the proof mass section 8A. The one end 12aA of the beam 2rA is identical to the support section 12hA of the detecting section 2A.

The detecting section 2A includes a first electrode 3A, a second electrode 4A, and a first piezoelectric film 6A and a second piezoelectric film 7A provided between the first electrode 3A and the second electrode 4A, and extends in the first direction (Y-axis direction) in a plane parallel to the major surface 1a of the substrate 1.

Here, in the detecting section 2A, the first electrode 3A is made of a first conductive film 3f, the second electrode 4A is made of a third conductive film 5f (film serving as at least one of first lower side conductive film and first substrate-side conductive film), the first piezoelectric film 6A is made of a first piezoelectric layer film 6f, and the second piezoelectric film 7A is made of a second piezoelectric layer film 7f.

The proof mass section 8A is composed of a first piezoelectric layer film 6f, a second conductive film 4f, a second piezoelectric layer film 7f, and a third conductive film 5f.

The side surface stopper section 10A is composed of the first piezoelectric layer film 6f, the second conductive film 4f, the second piezoelectric layer film 7f, and the third conductive film 5f, and is opposed to the side surface 8sA of the proof mass section 8A and spaced by a third gap 14A.

The upper surface stopper section 17 is provided on the opposite side of the proof mass section 8A and the detecting section 2A from the substrate 1 and spaced by a second gap 18A.

The first piezoelectric film 6A is polarized in the direction (Z-axis direction) perpendicular to the major surface 1a of the substrate 1.

The first electrode 3A is bisected widthwise into a first split electrode 3aA and a second split electrode 3bA.

On the other hand, the second inertial sensor 122B includes a beam 2rB having a detecting section 2B, a proof mass section 8B, a side surface stopper section 10B, and an upper surface stopper section 17.

One end 12aB of the beam 2rB is connected to the major surface 1a of the substrate 1.

The other end 12bB of the beam 2rB (detecting section 2B) is connected to the proof mass section 8B. The one end 12aB of the beam 2rB is identical to the support section 12hB of the detecting section 2B.

Although not shown, the detecting section 2B includes a first electrode 3B, a second electrode 4B, and a first piezoelectric film 6B and a second piezoelectric film 7B provided between the first electrode 3B and the second electrode 4B, and extends in the direction (X-axis direction) parallel to the major surface 1a of the substrate 1 and perpendicular to the first direction (Y-axis direction).

Here, in the detecting section 2B, the first electrode 3B is made of the first conductive film 3f, the second electrode 4B is made of the third conductive film 5f (film serving as at least one of second lower side conductive film and second substrate-side conductive film), the first piezoelectric film 6B is made of the first piezoelectric layer film 6f, and the second piezoelectric film 7B is made of the second piezoelectric layer film 7f.

Although not shown, the proof mass section 8B is composed of the first piezoelectric layer film 6f, the second conductive film 4f, the second piezoelectric layer film 7f, and the third conductive film 5f.

The side surface stopper section 10B is composed of the first piezoelectric layer film 6f, the second conductive film 4f, the second piezoelectric layer film 7f, and the third conductive film 5f, and is opposed to the side surface 8sB of the proof mass section 8B and spaced by a third gap 14B.

The upper surface stopper section 17 is provided on the opposite side of the proof mass section 8B and the detecting section 2B from the substrate 1 and spaced by a second gap 18B.

The first piezoelectric film 6B is polarized in the direction (Z-axis direction) perpendicular to the major surface 1a of the substrate 1.

The first electrode 3B is bisected widthwise into a first split electrode 3aB and a second split electrode 3bB.

On the other hand, the third inertial sensor 130 includes a beam 2rC (third beam) having a detecting section 2C (third detecting section), a proof mass section 8C (third proof mass section), a side surface stopper section 10C (third side surface stopper section), and an upper surface stopper section 17 (third upper surface stopper section).

One end 12aC of the beam 2rC is connected to the major surface 1a of the substrate 1.

The other end 12bC of the beam 2rC (detecting section 2C) is connected to the proof mass section 8C. The one end 12aC of the beam 2rC is identical to the support section 12hC of the detecting section 2C.

The detecting section 2C includes a first electrode 3C (third upper side electrode), a second electrode 4C (third lower side electrode), a first piezoelectric film 6C (third upper side piezoelectric film) provided between the first electrode 3C and the second electrode 4C, a third electrode 5C (third substrate-side electrode) provided on the opposite side of the second electrode 4C from the first electrode 3C, and a second piezoelectric film 7C (third lower side piezoelectric film) provided between the second electrode 4C and the third electrode 5C, and extends in the first direction (Y-axis direction) in a plane parallel to the major surface 1a of the substrate 1.

Here, in the detecting section 2C, the first electrode 3C is made of the first conductive film 3f (third upper side conductive film), the second electrode 4C is made of the second conductive film 4f (third lower side conductive film), the third electrode 5C is made of the third conductive film 5f (third substrate-side conductive film), the first piezoelectric film 6C is made of the first piezoelectric layer film 6f (third upper side piezoelectric layer film), and the second piezoelectric film 7C is made of the second piezoelectric layer film 7f (third lower side piezoelectric layer film). The proof mass section 8C is composed of the first piezoelectric layer film 6f, the second conductive film 4f, the second piezoelectric layer film 7f, and the third conductive film 5f.

The side surface stopper section 10C is composed of the first piezoelectric layer film 6f, the second conductive film 4f, the second piezoelectric layer film 7f, and the third conductive film 5f, and is opposed to the side surface 8sC of the proof mass section 8C and spaced by a third gap 14C.

The upper surface stopper section 17 is provided on the opposite side of the proof mass section 8C and the detecting section 2C from the substrate 1 and spaced by a second gap 18C.

The first piezoelectric film 6C is polarized in the direction (Z-axis direction) perpendicular to the major surface 1a of the substrate 1.

The first conductive film 3f serving as the first electrode 3A, 3B, the third conductive film 5f serving as the second electrode 4A, 4B, the first piezoelectric layer film 6f serving as the first piezoelectric film 6A, 6B, and the second piezoelectric layer film 7f serving as the second piezoelectric film 7A, 7B in the detecting section 2A, 2B of the first and second inertial sensor 122A, 122B are respectively made of the same films as the first conductive film 3f serving as the first electrode 3C, the third conductive film 5f serving as the third electrode 5C, the first piezoelectric layer film 6f serving as the first piezoelectric film 6C, and the second piezoelectric layer film 7f serving as the second piezoelectric film 7C in the detecting section 2C of the third inertial sensor 130.

Furthermore, the third conductive film 5f, the first piezoelectric layer film 6f, and the second piezoelectric layer film 7f in the proof mass section 8A, 8B and the side surface stopper section 10A, 10B of the first and second inertial sensor 122A, 122B are respectively made of the same films as the third conductive film 5f serving as the third electrode 5C, the first piezoelectric layer film 6f serving as the first piezoelectric film 6C, and the second piezoelectric layer film 7f serving as the second piezoelectric film 7C in the proof mass section 8C and the side surface stopper section 10C of the third inertial sensor 130.

The structure and operation of the first, second, and third inertial sensor 122A, 122B, 130 are described in detail in the first practical example and the third embodiment, and hence are not repeated here.

In the first inertial sensor 122A, the detecting section 2A extends in the Y-axis direction and is sensitive to acceleration in the X-axis direction. In the second inertial sensor 122B, the detecting section 2B extends in the X-axis direction and is sensitive to acceleration in the Y-axis direction. In the third inertial sensor 130, the detecting section 2C extends in the Y-axis direction and is sensitive to acceleration in the Z-axis direction.

The first, second, and third inertial sensor 122A, 122B, 130 can be placed accurately in the same substrate by a single process.

Hence, an output corresponding to acceleration in the X-axis direction can be obtained by a first differential amplifier (not shown) connected to the first and second split electrode 3aA, 3bA of the first inertial sensor 122A, an output corresponding to acceleration in the Y-axis direction can be obtained by a second differential amplifier (not shown) connected to the first and second split electrode 3aB, 3bB of the second inertial sensor 122B, and an output corresponding to acceleration in the Z-axis direction can be obtained by a third differential amplifier (not shown) connected to the second electrode 4C, and to the first and third electrode 3C, 5C short-circuited with each other, of the third inertial sensor 130.

Thus, the inertial sensor 310 according to this embodiment can realize a triaxial inertial sensor for three independent directions orthogonal to each other.

Thus, the inertial sensor 310 according to this embodiment can provide an ultrasmall inertial sensor having triaxial detection sensitivity which is capable of high-accuracy detection without temperature compensation and easy to manufacture.

As described above, the inertial sensor according to the embodiments of the invention includes a detecting section 2, a proof mass section 8, an upper surface stopper section 17, and a side surface stopper section 10, one end of the detecting section 2 being supported on a substrate 1 and the other end thereof being connected to the proof mass section 8, the detecting section 2 including a first electrode 3, a second electrode 4, and a first piezoelectric film 6 provided between the first electrode 3 and the second electrode 4, and extending in one direction (e.g., Y-axis direction) in a plane parallel to a major surface 1a of the substrate 1.

Application of acceleration to the proof mass section 8 causes a strain in the first piezoelectric film 6 of the detecting section 2, and charge depending on the strain occurs in the electrode (at least one of the first electrode 3 and the second electrode 4) of the detecting section 2.

If at least one of the first electrode 3 and the second electrode 4 is split, an acceleration applied in a direction perpendicular to the longitudinal direction (extending direction) of the detecting section 2 generates a voltage between the split electrodes.

Furthermore, if the detecting section 2 has a so-called bimorph structure which includes a second piezoelectric film 7 provided between the second electrode 4 and a third electrode 5 in addition to the first piezoelectric film 6 provided between the first electrode 3 and the second electrode 4, an acceleration applied in a direction perpendicular to the major surface 1a of the substrate 1 generates a voltage between the second electrode 4, and the first electrode 3 and the third electrode 5.

The magnitude of the acceleration can be measured by detecting these voltages.

Furthermore, a biaxial or triaxial inertial sensor can be constructed by using two or three or more of the aforementioned inertial sensors and arranging two of them perpendicularly in a plane parallel to the major surface 1a of the substrate 1.

Under external application of impact load, the proof mass section 8 is brought into contact with the upper surface stopper section 17 or the side surface stopper section 10 provided close to the proof mass section 8, which can prevent the detecting section 2 and the like from being subjected to excessive stress.

Thus, the present embodiments can provide an ultrasmall inertial sensor which is capable of high-accuracy detection without temperature compensation and easy to manufacture.

### Eleventh Embodiment

The inertial detecting device 810 according to the eleventh embodiment of the invention includes the aforementioned inertial sensor and a detecting circuit connected to at least one of the first electrode 3 and the second electrode 4 of the inertial sensor.

Here, the inertial sensor can be any of the inertial sensors according to the aforementioned embodiments and practical example, and variations thereof.

The detecting circuit can illustratively be at least one of the first to fourth differential amplifier circuit described above.

In the case where the inertial sensor includes a third electrode 5 in addition to the first electrode 3 and the second electrode 4, the detecting circuit is connected to at least one of the first electrode 3, the second electrode 4, and the third electrode 5.

In the case where at least one of the first electrode 3, the second electrode 4, and the third electrode 5 includes split electrodes, the detecting circuit can be connected to each of the split electrodes.

Thus, the inertial detecting device according to this embodiment including the inertial sensor according to the embodiments of the invention and a detecting circuit can provide an ultrasmall inertial detecting device which is capable of high-accuracy detection without temperature compensation and easy to manufacture.

At least part of the detecting circuit described above can be provided on the substrate 1 where the aforementioned inertial sensor is provided. This serves to realize an inertial detecting device with low noise, high sensitivity, and high accuracy.

### Twelfth Embodiment

The inertial sensors and the inertial detecting device of the above first to eleventh embodiment are examples of the inertial sensor and inertial detecting device for detecting acceleration. In the following, inertial sensors and an inertial detecting device for detecting angular rate are described.

Before the inertial sensor according to this embodiment is described in detail, the operating principle of an angular rate sensor is described.

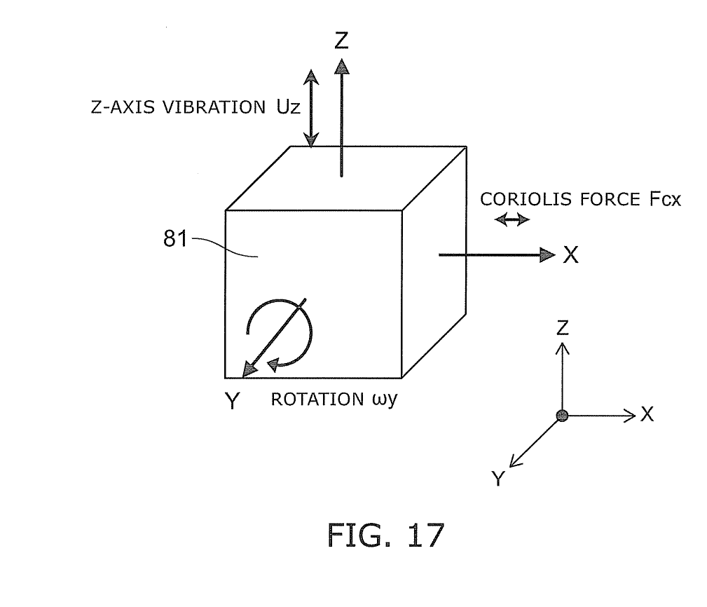

FIG. 17 is a schematic view illustrating the operating principle of an inertial sensor according to a twelfth embodiment of the invention.

The angular rate sensor based on the inertial sensor according to this embodiment detects angular rate using Coriolis force.

As shown in FIG. 17, suppose that a vibrator 81 is placed at the origin of an XYZ three-dimensional coordinate system. The angular rate ωy of this vibrator 81 about the Y axis can be detected by measuring the Coriolis force Fcx generated in the X-axis direction when a vibration Uz in the Z-axis direction is applied to this vibrator 81. The Coriolis force Fcx generated in this case is given by

Fcx=2m vz·ωy

where m is the mass of the vibrator 81, vz is the instantaneous velocity of the vibration of the vibrator 81, and ωy is the instantaneous angular rate of the vibrator 81.

Likewise, the angular rate cox of this vibrator 81 about the X axis can be detected by measuring the Coriolis force Fcy generated in the Y-axis direction.

Thus, the angular velocities ωx, ωy about the X and Y axis can be detected by using a mechanism for vibrating the vibrator 81 in the Z-axis direction, a mechanism for detecting the Coriolis force Fcx in the X-axis direction acting on the vibrator 81, and a mechanism for detecting the Coriolis force Fcy in the Y-axis direction.

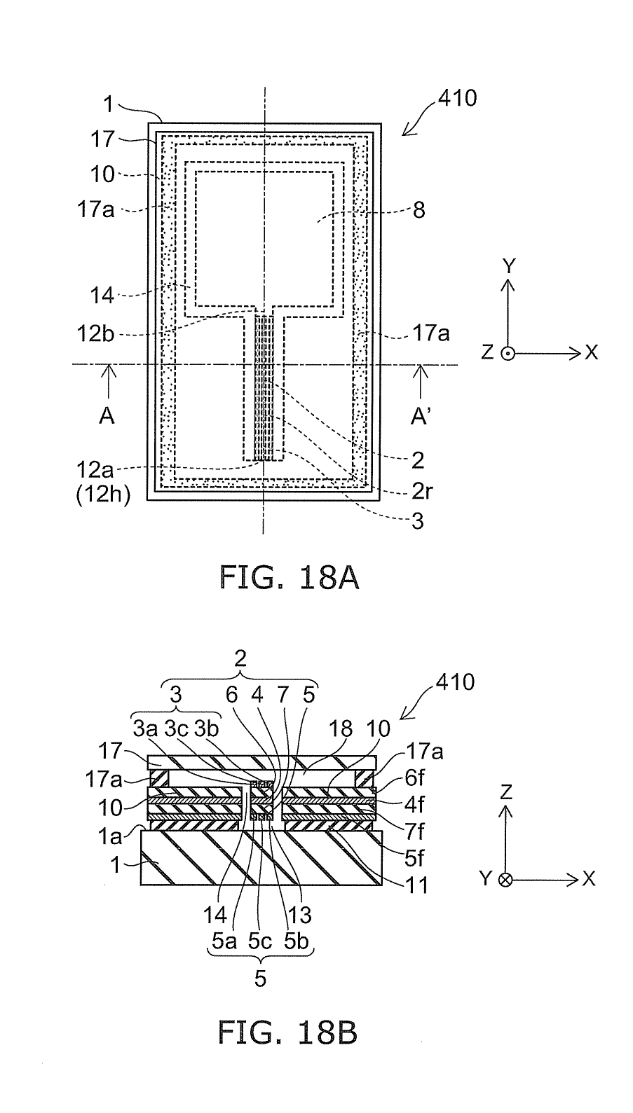

FIG. 18 is a schematic view illustrating the configuration of an inertial sensor according to a twelfth embodiment of the invention.

More specifically, FIG. 18A is a schematic plan view (top view), and FIG. 18B is a cross-sectional view taken along line A-A′ in FIG. 18A.

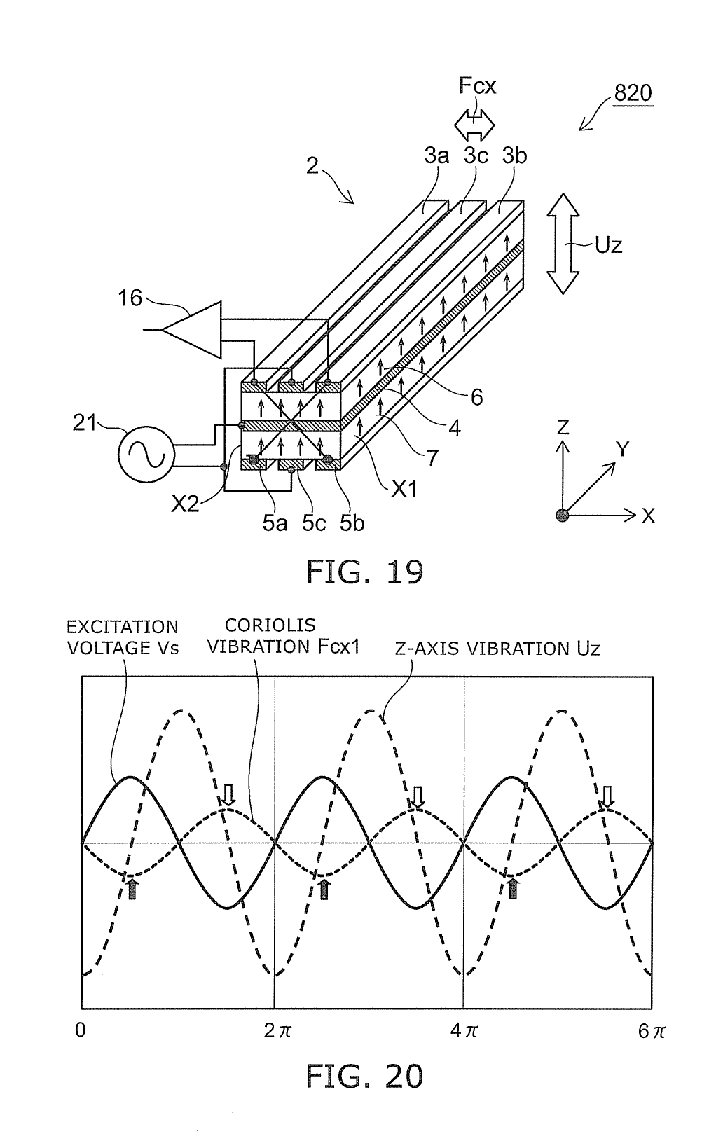

FIG. 19 is a schematic perspective view illustrating the operation of the inertial sensor according to the twelfth embodiment of the invention.

As shown in FIG. 18, the inertial sensor 410 according to the twelfth embodiment of the invention has a structure similar to that of the inertial sensor 140 according to the fourth embodiment.

More specifically, the inertial sensor 410 includes a beam 2r extending in a first direction (Y-axis direction) in a plane parallel to a major surface 1a of a substrate 1, held with a spacing (first gap 13) from the major surface 1a of the substrate 1, having a detecting section 2 including a first electrode 3, a second electrode 4, and a first piezoelectric film 6 provided between the first electrode 3 and the second electrode 4, and having one end 12a connected to the major surface 1a of the substrate 1; a proof mass section 8 connected to the other end 12b of the beam 2r and held with a spacing from the major surface 1a of the substrate 1; and an upper surface stopper section 17 provided on the opposite side of the proof mass section 8 from the substrate 1 with a spacing (second gap 18) from the proof mass section 8.

The detecting section 2 further includes a third electrode 5 provided on the opposite side of the second electrode 4 from the first piezoelectric film 6, and a second piezoelectric film 7 provided between the third electrode 5 and the second electrode 4. That is, the detecting section 2 has a bimorph structure.

On the other hand, the proof mass section 8 can include at least one of a first conductive film 3f serving as the first electrode 3, a second conductive film 4f serving as the second electrode 4, a third conductive film 5f serving as the third electrode 5, a first piezoelectric layer film 6f serving as the first piezoelectric film 6, and a second piezoelectric layer film 7f serving as the second piezoelectric film 7.

The detecting section 2 and the proof mass section 8 are formed generally coplanarly.

The detecting section 2 and the proof mass section 8 are formed axisymmetrically with respect to the first direction (Y-axis direction).

The inertial sensor 410 further includes a side surface stopper section 10 opposed to the side surface of the proof mass section 8 and spaced by a gap (third gap 14) from the side surface of the proof mass section 8.

This side surface stopper section 10 can include at least one of the first conductive film 3f serving as the first electrode 3, the second conductive film 4f serving as the second electrode 4, the third conductive film 5f serving as the third electrode 5, the first piezoelectric layer film 6f serving as the first piezoelectric film 6, and the second piezoelectric layer film 7f serving as the second piezoelectric film 7.

At least one of the first electrode 3 and the second electrode 4 can include a plurality of split electrodes extending in the first direction (Y-axis direction).

Specifically, the first electrode 3 is split widthwise (in the direction orthogonal to the extending direction) into a first split electrode 3a, a second split electrode 3b, and a third split electrode 3c. Furthermore, the third electrode 5 is also split widthwise into a fourth split electrode 5a, a fifth split electrode 5b, and a sixth split electrode 5c.

Here, the detecting section 2 in this embodiment has the function of excitation and detection, and hence it is referred to as “exciting/detecting section 2”.

As shown in FIG. 19, a differential amplifier 16 is connected to the first split electrode 3a and the second split electrode 3b, and to the fourth split electrode 5a and the fifth split electrode 5b. On the other hand, an oscillating circuit 21 is connected to the second electrode 4 and to the third split electrode 3c and the sixth split electrode 5c.

In general, a piezoelectric film has the property of generating a pressure in a prescribed direction inside the piezoelectric element upon external application of voltage to the piezoelectric film.

A description is given of the phenomenon which occurs upon application of voltage between the second electrode 4, and the third split electrode 3c and the sixth split electrode 5c illustrated in FIG. 19.

For example, a positive voltage is applied to the second electrode 4 of the exciting/detecting section 2, and a negative voltage is applied to the third split electrode 3c and the sixth split electrode 5c. Here, the first piezoelectric film 6 is polarized in the Z-axis direction. Hence, in the first piezoelectric film 6, a compressive stress occurs in the thickness direction (Z-axis direction), and a tensile stress occurs in the X-axis and Y-axis direction. Furthermore, the second piezoelectric film 7 is also polarized in the Z-axis direction. Hence, in the second piezoelectric film 7, a tensile stress occurs in the Z-axis direction, and a compressive stress occurs in the X-axis and Y-axis direction.

Hence, the exciting/detecting section 2 is bent convex with respect to the positive Z-axis direction. Thus, the proof mass section 8 is displaced toward the positive side along the Z axis.

Furthermore, if the polarity of the voltage supplied to the second electrode 4 and to the third split electrode 3c and the sixth split electrode is reversed, the expansion/contraction state of the piezoelectric film is also reversed, and the proof mass section 8 is displaced toward the negative side along the Z axis.

The proof mass section 8 can be reciprocated in the Z-axis direction by alternately reversing the polarity of the supply voltage so that these two displacement states alternately occur. In other words, the proof mass section 8 can be subjected to vibration in the Z-axis direction, that is, Z-axis vibration Uz. Such supply of voltage can be realized by applying an AC signal between the opposed electrodes. That is, the aforementioned proof mass section 8 can be subjected to Z-axis vibration Uz in the Z-axis direction by causing the oscillating circuit 21 connected to the second electrode 4 and to the third split electrode 3c and the sixth split electrode 5c to apply an AC signal between the second electrode 4, and the third split electrode 3c and the sixth split electrode 5c.

Next, a method for detecting Coriolis force in the inertial sensor 410 according to the twelfth embodiment is described.

The mechanism for detecting Coriolis force is basically the same as the mechanism for detecting acceleration described in the fourth embodiment, for example.

First, as shown in FIG. 19, if the proof mass section 8 is vibrated in the Z-axis direction by the aforementioned vibrating mechanism, and a rotation about the Y axis is applied at this time, then a Coriolis force Fcx is applied in the X-axis direction as described above. This Coriolis force Fcx can be measured like the force Fx caused by acceleration. More specifically, the polarity of charge is opposite between the first split electrode 3a and the second split electrode 3b, and between the fourth split electrode 5a and the fifth split electrode 5b. The magnitude of the Coriolis force Fcx applied in the X-axis direction can be detected by using the differential amplifier 16 to measure the voltage between the first split electrode 3a and the second split electrode 3b, or between the fourth split electrode 5a and the fifth split electrode 5b.

On the other hand, as described in the fourth embodiment, the inertial sensor 410 according to this embodiment is charged also by the acceleration Fx in the X-axis direction. That is, an electromotive force Vx is generated in the differential amplifier 16a illustrated in FIG. 9.

As described below, there are two methods for discriminating between the electromotive force caused by the aforementioned Coriolis force Fcx in the X-axis direction and the electromotive force Vx caused by the acceleration Fx.

The first method is based on a frequency filter. Most of the frequency components of the acceleration applied to the inertial sensor are typically below several ten Hz, whereas the Coriolis force can include the vibration frequency of the exciting/detecting section 2. Hence, if the frequency of the signal (excitation voltage Vs) generated by the oscillating circuit 21 is adjusted to set the excitation frequency of the exciting/detecting section 2 in the range from approximately several kHz to several ten kHz, and a high-pass filter having a cutoff frequency of several hundred Hz is connected to the differential amplifier 16, then only the Coriolis force component in synchronization with the vibration frequency can be obtained as output. Thus, the electromotive force caused by the Coriolis force Fcx and the electromotive force Vx caused by the acceleration Fx can be separated from each other.

The second method for discriminating between the electromotive force caused by the Coriolis force Fcx and the electromotive force Vx caused by the acceleration Fx is to perform A/D conversion in synchronization with the excitation period or vibration period to directly determine the electromotive force resulting from the Coriolis force.

FIG. 20 is a schematic view illustrating the operation of the inertial sensor according to the twelfth embodiment of the invention.

This figure illustrates the phase relationship among the excitation voltage Vs, the Z-axis vibration Uz, and the Coriolis vibration Fcx1 caused by the Coriolis force Fcx in the X-axis direction, where the horizontal axis represents phase, and the vertical axis represents the amplitude of excitation voltage Vs, Z-axis vibration Uz, and Coriolis vibration Fcx1.

As shown in FIG. 20, the Z-axis vibration Uz lags n/2 in phase behind the excitation voltage Vs. The vibration caused by the Coriolis force in the X-axis direction (Coriolis vibration Fcx1) lags n/2 behind the Z-axis vibration Uz. Hence, the vibration caused by the Coriolis force in the X-axis direction (Coriolis vibration Fcx1) lags n behind the excitation voltage Vs.

Thus, if the electromotive force corresponding to the Coriolis vibration Fcx1 obtained by the differential amplifier 16 is sampled and A/D converted at a phase of (2n+1/2)n and (2n+3/2)n shifted from the phase of the excitation voltage Vs, then the maximum and minimum of the electromotive force can be obtained. The Coriolis force can be measured from the difference between these maximum and minimum. On the other hand, the mean value of the maximum and minimum corresponds to the acceleration in the X-axis direction.

Thus, the exciting/detecting section 2 for detecting the Coriolis force Fcx in the X-axis direction can be used to detect only the Coriolis force in the X-axis direction. This is not affected by the vibration in the Z-axis direction and the acceleration in the X-axis direction (let alone the acceleration in the Y-axis and Z-axis direction).

On the other hand, under application of impact load, the inertial sensor 410 provides similar performance to that of, for example, the inertial sensor 140 according to the fourth embodiment described above. More specifically, the structural strength is high in the Y-axis direction, and there is no problem with impact load applied in the Y-axis direction. When an impact load is applied in the X-axis direction, the proof mass section 8 is brought into contact with the side surface stopper section 10 and restricted in its bending deformation, which can prevent the detecting section 2 and the like from being broken by application of excessive stress. Furthermore, when an impact load is applied in the Z-axis direction, the proof mass section 8 is brought into contact with the substrate 1 or the upper surface stopper section 17 and restricted in its bending deformation, which can prevent the detecting section 2 and the like from being broken by application of excessive stress.

Thus, the inertial sensor 410 according to this embodiment can realize an inertial sensor being sensitive to rotation velocity (angular rate) in the Y-axis direction and having sufficient resistance to impact force in the X-axis, Y-axis, and Z-axis direction.

In the inertial sensor 410 according to this embodiment, an AC signal is applied between the second electrode 4, and the third split electrode 3c and the sixth split electrode 5c, of the exciting/detecting section 2 to cause excitation in the Z-axis direction, and the voltage at least one of between the first split electrode 3a and the second split electrode 3b, and between the fourth split electrode 5a and the fifth split electrode 5b is measured to measure the Coriolis force induced in the X-axis direction. However, in inertial sensor according to this embodiment, the electrodes for excitation and the electrodes for detection can be connected in reverse. That is, for example, an AC signal can be applied between the first split electrode 3a and the second split electrode 3b, and between the fourth split electrode 5a and the fifth split electrode 5b, of the exciting/detecting section 2 to cause excitation in the X-axis direction, and the voltage between the second electrode 4, and the third split electrode 3c and the sixth split electrode 5c, can be measured to measure the Coriolis force induced in the Z-axis direction.

### Thirteenth Embodiment

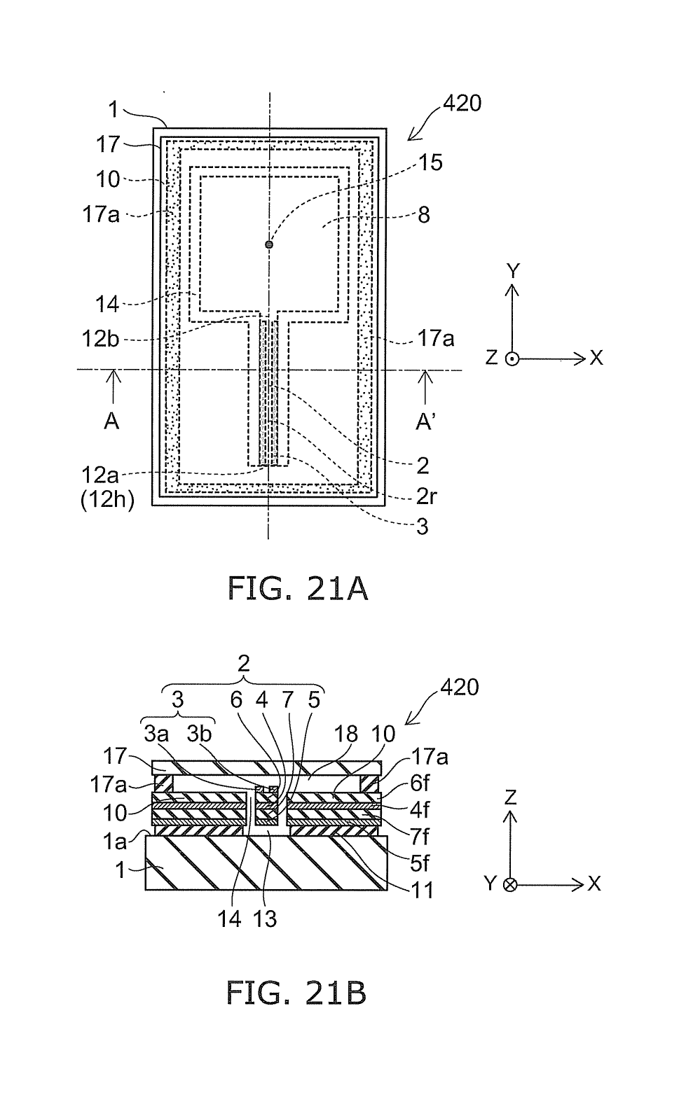

FIG. 21 is a schematic view illustrating the configuration of an inertial sensor according to a thirteenth embodiment of the invention.

More specifically, FIG. 21A is a schematic plan view (top view), and FIG. 21B is a cross-sectional view taken along line A-A′ in FIG. 21A.

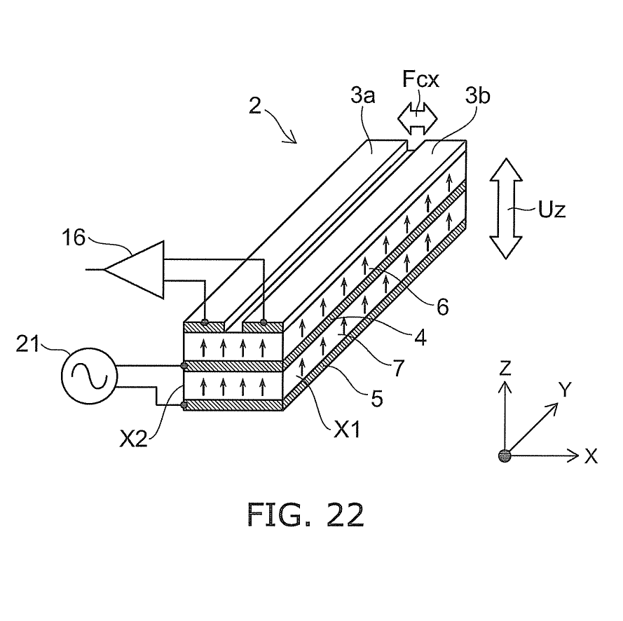

FIG. 22 is a schematic perspective view illustrating the operation of the inertial sensor according to the thirteenth embodiment of the invention.

As shown in FIG. 21, the inertial sensor 420 according to the thirteenth embodiment of the invention has a configuration similar to that of the inertial sensor 150 according to the fifth embodiment illustrated in FIGS. 10 and 11. However, the inertial sensor according to the thirteenth embodiment of the invention is another example of the inertial sensor which can detect angular rate by vibrating the detecting section 2.

As shown in FIG. 21, in the inertial sensor 420 according to the thirteenth embodiment of the invention, like the inertial sensor 150, the detecting section 2 has a structure in which a first electrode 3, a first piezoelectric film 6, a second electrode 4, a second piezoelectric film 7, and a third electrode 5 are stacked. That is, the detecting section 2 has a bimorph structure. The first electrode 3 is split widthwise into a first split electrode 3a and a second split electrode 3b. However, the third electrode 5 is not split.

In the inertial sensor 420 according to this embodiment, the detecting section 2 has the function of excitation and detection, and hence it is referred to as “exciting/detecting section 2”.

As shown in FIG. 22, a differential amplifier 16 is connected to the first split electrode 3a and the second split electrode 3b of the exciting/detecting section 2.

On the other hand, an oscillating circuit 21 is connected to the second electrode 4 and the third electrode 5 of the exciting/detecting section 2.

Like the inertial sensor 410 according to the twelfth embodiment, also in the inertial sensor 420 according to this embodiment, the proof mass section 8 can be vibrated in the Z-axis direction by applying an AC signal between the second electrode 4 and the third electrode 5.

If a rotation about the Y axis is applied at this time, then a Coriolis force Fcx is applied in the X-axis direction as described above. Here, the magnitude of the Coriolis force Fcx applied in the X-axis direction can be detected by using the differential amplifier 16 to measure the voltage between the first split electrode 3a and the second split electrode 3b.

Also in the inertial sensor 420 according to this embodiment, a technique similar to that for the inertial sensor 410 described above can be used to separate the electromotive force caused by the Coriolis force Fcx and the electromotive force Vx caused by the acceleration Fx from each other.

On the other hand, under application of impact load, the inertial sensor 420 provides similar performance to that of, for example, the inertial sensor 150 according to the fifth embodiment described above. More specifically, the structural strength is high in the Y-axis direction, and there is no problem with impact load applied in the Y-axis direction. When an impact load is applied in the X-axis direction, the proof mass section 8 is brought into contact with the side surface stopper section 10 and restricted in its bending deformation, which can prevent the detecting section 2 and the like from being broken by application of excessive stress. Furthermore, when an impact load is applied in the Z-axis direction, the proof mass section 8 is brought into contact with the substrate 1 or the upper surface stopper section 17 and restricted in its bending deformation, which can prevent the detecting section 2 and the like from being broken by application of excessive stress.

Thus, the inertial sensor 420 according to this embodiment can realize an inertial sensor being sensitive to rotation velocity (angular rate) about the Y axis and having sufficient resistance to impact force in the X-axis, Y-axis, and Z-axis direction.

### Fourteenth Embodiment

The inertial sensor 410, 420 according to the twelfth and thirteenth embodiment described above is a so-called one-legged inertial sensor for detecting angular rate, which has a single exciting/detecting section 2 and proof mass section 8. In contrast, the inertial sensor according to the fourteenth embodiment of the invention is a two-legged inertial sensor for detecting angular rate. This inertial sensor is characterized in that two proof mass sections 8 are excited in opposite phase, which allows the overall momentum of the proof mass sections 8 to be canceled out and increases the detection accuracy of angular rate.

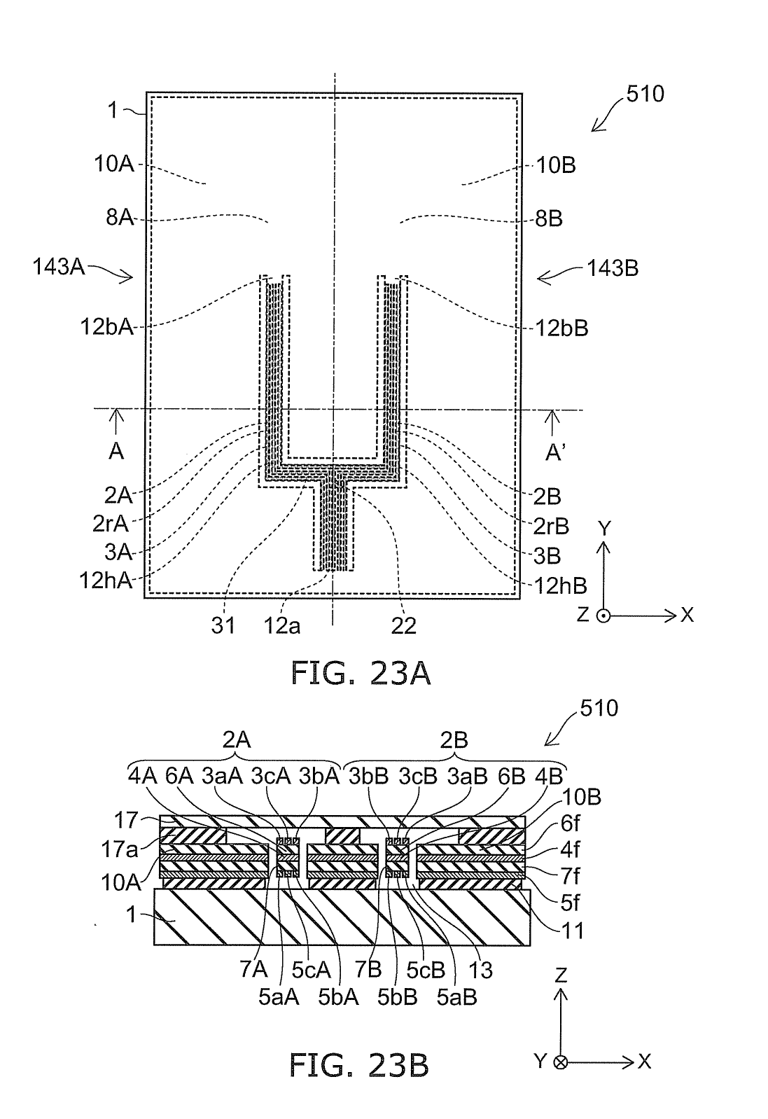

FIG. 23 is a schematic view illustrating the configuration of an inertial sensor according to a fourteenth embodiment of the invention.

More specifically, FIG. 23A is a schematic plan view (top view), and FIG. 23B is a cross-sectional view taken along line A-A′ in FIG. 23A.

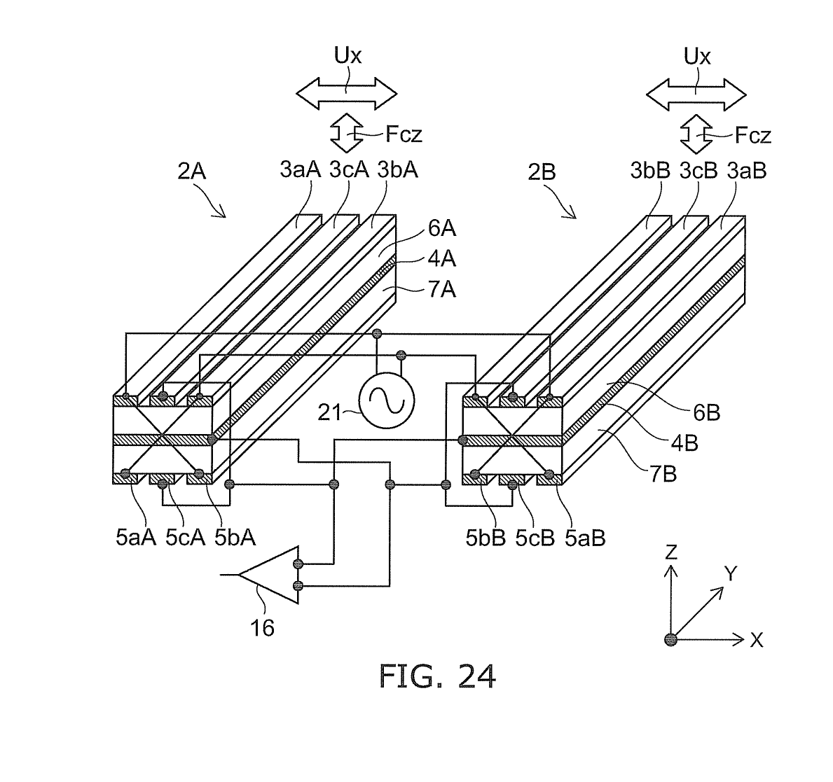

FIG. 24 is a schematic perspective view illustrating the operation of the inertial sensor according to the fourteenth embodiment of the invention.

As shown in FIG. 23, the inertial sensor 510 according to the fourteenth embodiment of the invention includes two copies of the exciting/detecting section 2 in the inertial sensor 410 illustrated in FIG. 18, that is, a first exciting/detecting section 2A and a second exciting/detecting section 2B.

In other words, the inertial sensor 510 includes a first inertial sensor 143A and a second inertial sensor 143B which are similar in structure to the inertial sensor 140 according to the fourth embodiment illustrated in FIG. 8.

The first inertial sensor 143A includes a first beam 2rA extending in a first direction (Y-axis direction) in a plane parallel to a major surface 1a of a substrate 1, held with a spacing from the major surface 1a of the substrate 1, having a first detecting section 2A (first exciting/detecting section 2A) including a first electrode 3A, a second electrode 4A, and a first piezoelectric film 6A provided between the first electrode 3A and the second electrode 4A, and having one end 12a connected to the major surface 1a of the substrate 1.

That is, the first beam 2rA includes a first detecting section 2A and a base section 31 to which the support section 12hA of the first detecting section 2A is connected. One end 12a of the base section 31 is connected to the major surface 1a of the substrate 1, and thereby the first beam 2rA is held with a spacing from the major surface 1a of the substrate 1.

The first inertial sensor 143A further includes a first proof mass section 8A connected to the other end 12bA of the first beam 2rA and held with a spacing from the major surface 1a of the substrate 1.

In this example, the first detecting section 2A further includes a third electrode 5A provided on the opposite side of the second electrode 4A from the first electrode 3A, and a second piezoelectric film 7A provided between the second electrode 4A and the third electrode 5A.

Furthermore, the second inertial sensor 143B includes a second beam 2rB extending in the first direction (Y-axis direction) in a plane parallel to the major surface 1a of the substrate 1, held with a spacing from the major surface 1a of the substrate 1, having a second detecting section 2B (second exciting/detecting section 2B) including a first electrode 3B, a second electrode 4B, and a first piezoelectric film 6B provided between the first electrode 3B and the second electrode 4B, and having one end 12a connected to the major surface 1a of the substrate 1.

That is, the second beam 2rB includes a second detecting section 2B and the base section 31 to which the support section 12hB of the second detecting section 2B is connected, the base section 31 being shared with the first beam 2rA. One end 12a of the base section 31 is connected to the major surface 1a of the substrate 1, and thereby the second beam 2rB is held with a spacing from the major surface 1a of the substrate 1.

The second inertial sensor 143B further includes a second proof mass section 8B connected to the other end 12bB of the second beam 2rB and held with a spacing from the major surface 1a of the substrate 1.

In this example, the second detecting section 2B further includes a third electrode 5B provided on the opposite side of the second electrode 4B from the first electrode 3B, and a second piezoelectric film 7B provided between the second electrode 4B and the third electrode 5B.

From a different viewpoint, the structure of the inertial sensor 510 according to this embodiment includes a base section 31 connected at one end 12a to the major surface 1a of the substrate 1, held with a spacing from the major surface 1a of the substrate 1, and having a T-shaped branching section 22, and two exciting/detecting sections provided at the ends of the branching section 22.

That is, the first detecting section 2A and the second detecting section 2B are connected to the major surface 1a of the substrate 1 by the base section 31.

In the first exciting/detecting section 2A, the first electrode 3A is made of a first conductive film 3f, the first piezoelectric film 6A is made of a first piezoelectric layer film 6f, the second electrode 4A is made of a second conductive film 4f, the second piezoelectric film 7A is made of a second piezoelectric layer film 7f, and the third electrode 5A is made of a third conductive film 5f. Likewise, in the second exciting/detecting section 2B, the first electrode 3B is made of the first conductive film 3f, the first piezoelectric film 6B is made of the first piezoelectric layer film 6f, the second electrode 4B is made of the second conductive film 4f, the second piezoelectric film 7B is made of the second piezoelectric layer film 7f, and the third electrode 5B is made of the third conductive film 5f.

The base section 31 can have a stacked structure of the first conductive film 3f, the first piezoelectric layer film 6f, the second conductive film 4f, the second piezoelectric layer film 7f, and the third conductive film 5f.

On the other hand, the first and second proof mass section 8A, 8B, and the side surface stopper section 10A, 10B can be illustratively composed of the first piezoelectric layer film 6f, the second conductive film 4f, the second piezoelectric layer film 7f, and the third conductive film 5f.

Here, the first and second exciting/detecting section 2A, 2B and the first and second proof mass section 8A, 8B are separated from the substrate 1 by a first gap 13.

The side surface stopper section 10A, 10B is fixed to the substrate 1 via a sacrificial layer 11.

The first and second exciting/detecting section 2A, 2B and the first and second proof mass section 8A, 8B are separated from an upper surface stopper section 17 by a second gap 18.

The side surface stopper section 10A, 10B is opposed to the side surface of the first and second proof mass section 8A, 8B. The first and second proof mass section 8A, 8B are separated from the side surface stopper section 10A, 10B by a third gap 14.

The first piezoelectric film 6A, 6B and the second piezoelectric film 7A, 7B are polarized in the same direction (Z-axis direction) perpendicular to the major surface 1a of the substrate 1.

In the first exciting/detecting section 2A, the first electrode 3A is split widthwise into a first split electrode 3aA, a second split electrode 3bA, and a third split electrode 3cA. Likewise, in the second exciting/detecting section 2B, the first electrode 3B is split widthwise into a first split electrode 3aB, a second split electrode 3bB, and a third split electrode 3cB.

Furthermore, in the first exciting/detecting section 2A, the third electrode 5A is split widthwise into a fourth split electrode 5aA, a fifth split electrode 5bA, and a sixth split electrode 5cA. Likewise, in the second exciting/detecting section 2B, the third electrode 5B is split widthwise into a fourth split electrode 5aB, a fifth split electrode 5bB, and a sixth split electrode 5cB.

The first split electrode 3aA, the second split electrode 3bA, and the third split electrode 3cA are axisymmetric to the first split electrode 3aB, the second split electrode 3bB, and the third split electrode 3cB with respect to the Y axis. Likewise, the fourth split electrode 5aA, the fifth split electrode 5bA, and the sixth split electrode 5cA are axisymmetric to the fourth split electrode 5aB, the fifth split electrode 5bB, and the sixth split electrode 5cB with respect to the Y axis.

As shown in FIG. 24, an oscillating circuit 21 is connected between the first split electrode 3aA and the second split electrode 3bA, between the first split electrode 3aB and the second split electrode 3bB, between the fourth split electrode 5aA and the fifth split electrode 5bA, and between the fourth split electrode 5aB and the fifth split electrode 5bB. Thus, the first and second proof mass section 8A, 8B can be vibrated in the X-axis direction by causing the oscillating circuit 21 to apply an AC voltage to the first and second exciting/detecting section 2A, 2B.

Here, the first and second exciting/detecting section 2A, 2B are driven symmetrically with respect to the Y axis, that is, in opposite phase. More specifically, when the first exciting/detecting section 2A is driven to the +X direction, the second exciting/detecting section 2B is driven to the −X direction. Hence, the momenta cancel out each other, and no overall vibration occurs in the sensor.

If a rotation about the Y axis is applied at this time, then a Coriolis force Fcz is applied in the Z-axis direction. This Coriolis force is also excited in opposite phase.

On the other hand, a differential amplifier 16 is connected in opposite phase between the third split electrode 3cA, 3cB and the second electrode 4A, 4B, and between the second electrode 4A, 4B and the sixth split electrode 5bA, 5bB. Thus, the magnitude of the Coriolis force Fcz applied in the Z direction can be detected by measuring the excited voltage.

On the other hand, under application of impact load, the inertial sensor 510 provides similar performance to that of the inertial sensors according to the embodiments described above. More specifically, the structural strength is high in the Y-axis direction, and there is no problem with impact load applied in the Y-axis direction. When an impact load is applied in the X-axis direction, the first and second proof mass section 8A, 8B are brought into contact with the side surface stopper section 10 and restricted in its bending deformation, which can prevent the first and second detecting section 2A, 2B and the like from being broken by application of excessive stress. Furthermore, when an impact load is applied in the Z-axis direction, the first and second proof mass section 8A, 8B are brought into contact with the substrate 1 or the upper surface stopper section 17 and restricted in its bending deformation, which can prevent the first and second detecting section 2A, 2B and the like from being broken by application of excessive stress.

Thus, the inertial sensor 510 according to this embodiment can realize an inertial sensor being sensitive to rotation velocity (angular rate) about the Y axis and having sufficient resistance to impact force in the X-axis, Y-axis, and Z-axis direction.

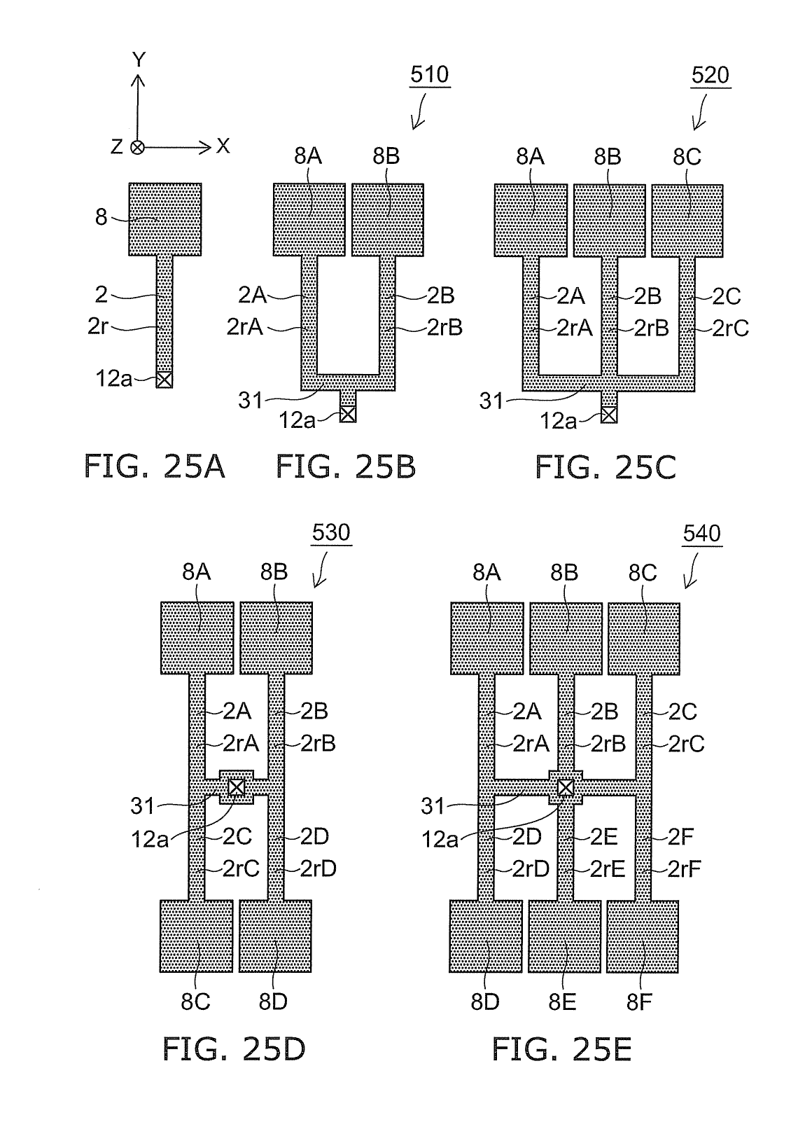

FIG. 25 is a schematic plan view showing variations of the inertial sensor according to the embodiments of the invention.

More specifically, this figure illustrates various variations of the exciting/detecting section 2 and the proof mass section 8 in the inertial sensor according to the embodiments of the invention.

FIG. 25A illustrates the exciting/detecting section 2 of the inertial sensor according to the twelfth and thirteenth embodiment described above. This inertial sensor includes one set of the exciting/detecting section 2 and the proof mass section 8, that is, it is a one-legged inertial sensor.

FIG. 25B illustrates the exciting/detecting section 2 and the proof mass section 8 of the inertial sensor according to the fourteenth embodiment described above. This example is a two-legged inertial sensor, which includes the first and second beam 2rA, 2rB having the first and second exciting/detecting section 2A, 2B, and the first and second proof mass section 8A, 8B connected thereto, the first and second exciting/detecting section 2A, 2B being connected by the base section 31. That is, the first and second beam 2rA, 2rB share the base section 31 and one end 12a, and are connected to the major surface 1a of the substrate 1 by the one end 12a.

As shown in FIG. 25C, the inertial sensor 520 of a variation according to this embodiment is a three-legged inertial sensor. More specifically, the inertial sensor 520 includes a first, second, and third beam 2rA, 2rB, 2rC having a first, second, and third exciting/detecting section 2A, 2B, 2C, and a first, second, and third proof mass section 8A, 8B, 8C connected thereto, the first, second, and third exciting/detecting section 2A, 2B, 2C being connected by a base section 31. That is, the first, second, and third beam 2rA, 2rB, 2rC share the base section 31 and one end 12a, and are connected to the major surface 1a of the substrate 1 by the one end 12a. Furthermore, the first proof mass section 8A and the third proof mass section 8C located outside are driven in phase, and the second proof mass section 8B at the center is driven in opposite phase.

As shown in FIG. 25D, the inertial sensor 530 of another variation according to this embodiment includes two copies of the two-legged inertial sensor 510 illustrated in FIG. 25B, the two-legged inertial sensors 510 being symmetric with respect to the X axis.

As shown in FIG. 25E, the inertial sensor 540 of another variation according to this embodiment includes two copies of the three-legged inertial sensor 520 illustrated in FIG. 25C, the three-legged inertial sensors 520 being symmetric with respect to the X axis.

Thus, the inertial sensors according to this embodiment allow various variations.

### Fifteenth Embodiment

The inertial detecting device according to the fifteenth embodiment of the invention is an inertial detecting device which can detect angular rate.

The inertial detecting device 820 according to the fifteenth embodiment of the invention includes the inertial sensor according to the twelfth to fourteenth embodiment of the invention, a detecting circuit connected to at least one of the first electrode 3 and the second electrode 4 of the inertial sensor, and an oscillating circuit 21 connected to at least one of the first electrode 3 and the second electrode 4 of the inertial sensor. That is, the inertial detecting device 820 according to this embodiment further includes an oscillating circuit 21 illustrated in FIG. 19, for example, in addition to the inertial detecting device 810 according to the eleventh embodiment.

The detecting circuit can illustratively be at least one of the first to fourth differential amplifier circuit described above.

The inertial sensor used in the inertial detecting device according to this embodiment is an inertial sensor including a third electrode 5 in addition to the first electrode 3 and the second electrode 4.

The detecting circuit is connected to at least one of the first electrode 3, the second electrode 4, and the third electrode 5.

In the case where at least one of the first electrode 3, the second electrode 4, and the third electrode 5 includes split electrodes, the detecting circuit can be connected to each of the split electrodes.

The oscillating circuit 21 is connected to at least one of the first electrode 3, the second electrode 4, and the third electrode 5.

In the case where at least one of the first electrode 3, the second electrode 4, and the third electrode 5 includes split electrodes, the oscillating circuit 21 can be connected to each of the split electrodes.

Thus, the inertial detecting device 820 according to this embodiment including the inertial sensor according to the embodiments of the invention, a detecting circuit, and an oscillating circuit can provide an ultrasmall inertial detecting device for detecting angular rate, which is capable of high-accuracy detection without temperature compensation and easy to manufacture.

At least part of at least one of the detecting circuit and the oscillating circuit 21 described above can be provided on the substrate 1 where the aforementioned inertial sensor is provided. This serves to realize an inertial detecting device with low noise, high sensitivity, and high accuracy.

### Sixteenth Embodiment

The inertial sensor according to the sixteenth embodiment of the invention is an inertial sensor for detecting biaxial angular acceleration.

That is, biaxial angular acceleration can be detected by using two inertial sensors for detecting biaxial acceleration to obtain a difference between the outputs of the two sensors.

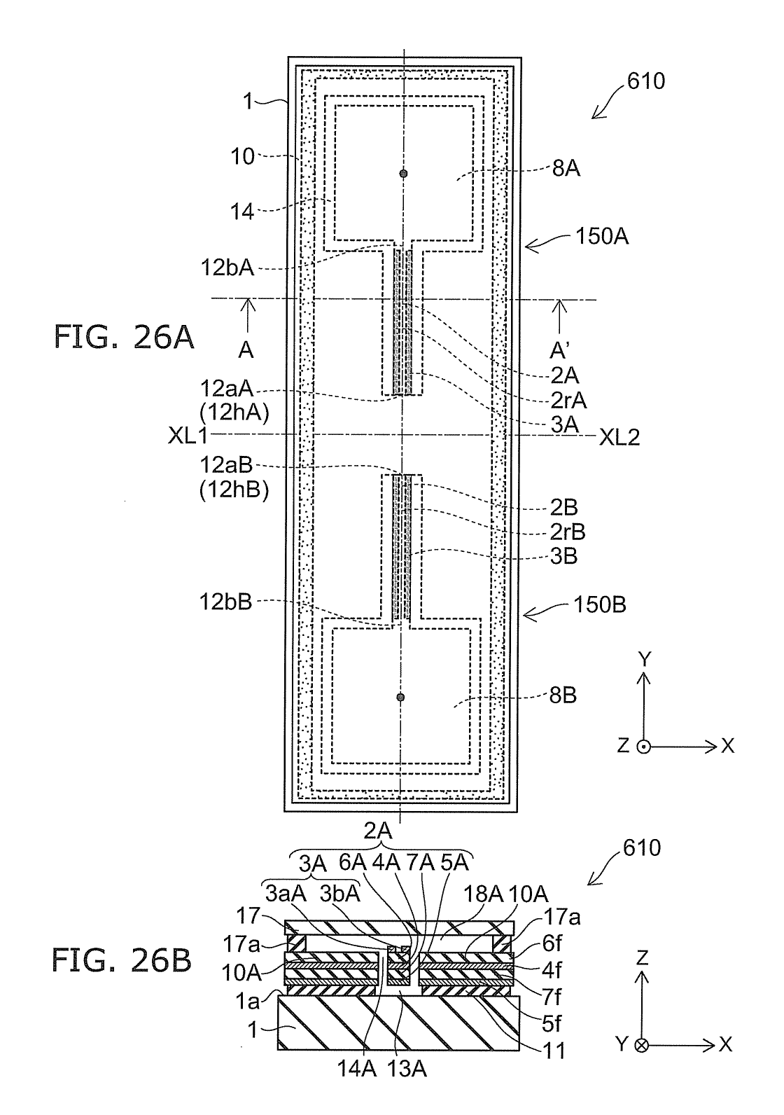

FIG. 26 is a schematic view illustrating the configuration of an inertial sensor according to a sixteenth embodiment of the invention.

More specifically, FIG. 26A is a schematic plan view (top view), and FIG. 26B is a cross-sectional view taken along line A-A′ in FIG. 26A.

As shown in FIG. 26, the inertial sensor 610 according to the sixteenth embodiment of the invention includes two copies of the detecting section 2 in the inertial sensor 150 illustrated in FIGS. 10 and 11.

More specifically, the inertial sensor 610 according to this embodiment includes a first inertial sensor 150A and a second inertial sensor 150B. The first inertial sensor 150A includes a first beam 2rA having a first detecting section 2A, and a first proof mass section 8A. The second inertial sensor 150B includes a second beam 2rB having a second detecting section 2B, and a second proof mass section 8B. The first and second detecting section 2A, 2B extend in the first direction (Y-axis direction) in a plane parallel to a major surface 1a of a substrate 1.

The first detecting section 2A and the first proof mass section 8A are axisymmetric to the second detecting section 2B and the second proof mass section 8B with respect to the direction (X-axis direction) perpendicular to the first direction. That is, as shown in FIG. 26A, they are axisymmetric with respect to line XL1-XL2.

The structure of the first and second detecting section 2A, 2B and the first and second proof mass section 8A, 8B is similar to that of the detecting section 2 and the proof mass section 8, respectively, of the inertial sensor 150 according to the fifth embodiment, and hence the detailed description thereof is omitted.

When an acceleration in the Z-axis direction is applied to the inertial sensor 610 according to this embodiment, like the fifth embodiment, the first and second proof mass section 8A, 8B are displaced toward the same side along the Z axis.

On the other hand, when an angular acceleration about the X axis is applied, for example, the first proof mass section 8A is displaced toward the positive (or negative) side along the Z axis, and at this time, the second proof mass section 8B is displaced toward the negative (or positive) side along the Z axis. That is, the first and second proof mass section 8A, 8B are displaced toward the opposite sides along the Z axis.

When an acceleration in the X-axis direction is applied, the first and second proof mass section 8A, 8B are displaced toward the same side along the X axis, like the fifth embodiment.

On the other hand, when an angular acceleration about the Z axis is applied, the first proof mass section 8A is displaced toward the positive (or negative) side along the X axis, and at this time, the second proof mass section 8B is displaced toward the negative (or positive) side along the X axis. That is, the first and second proof mass section 8A, 8B are displaced toward the opposite sides along the X axis.

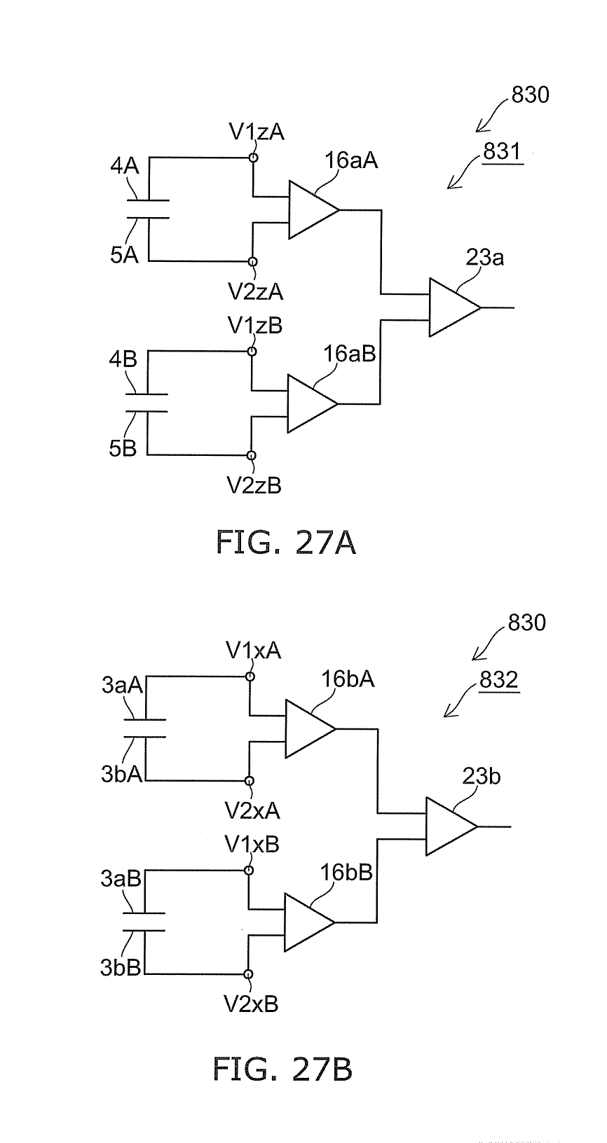

FIG. 27 is a circuit diagram illustrating a circuit connected to the inertial sensor according to the sixteenth embodiment of the invention.

More specifically, FIG. 27A illustrates a circuit for detecting angular acceleration about the X axis, and FIG. 27B illustrates a circuit for detecting angular acceleration about the Z axis. As shown in FIG. 27A, in the detecting circuit 831 for detecting angular acceleration about the X axis, the potential difference between the potential V1zA of the second electrode 4A and the potential V2zA of the third electrode 5A of the first detecting section 2A is detected by a differential amplifier 16aA. Likewise, the potential difference between the potential V1zB of the second electrode 4B and the potential V2zB of the third electrode 5B of the second detecting section 2B, which is paired with the first detecting section 2A, is detected by a differential amplifier 16aB. The difference between the outputs of the differential amplifier 16aA and the differential amplifier 16aB is detected by a differential amplifier 23a.

Thus, the difference of displacement in the Z-axis direction, caused by the angular acceleration about the X axis, between the first and second proof mass section 8A, 8B paired with each other can be detected to determine the magnitude of the angular acceleration.

Here, if an acceleration in the Z-axis direction is applied, the first and second proof mass section 8A, 8B are displaced by the same amount in the Z-axis direction. Hence, these displacements are canceled out in the process of obtaining the difference by the differential amplifier 23a, and only the angular acceleration component about the X axis is determined.

As shown in FIG. 27B, in the detecting circuit 832 for detecting angular acceleration about the Z axis, the potential difference between the potential V1xA of the first split electrode 3aA and the potential V2xA of the second split electrode 3bA of the first detecting section 2A is detected by a differential amplifier 16bA. Likewise, the potential difference between the potential V1xB of the first split electrode 3aB and the potential V2xB of the second split electrode 3bB of the second detecting section 2B, which is paired with the first detecting section 2A, is detected by a differential amplifier 16bB. The difference between the outputs of the differential amplifier 16bA and the differential amplifier 16bB is detected by a differential amplifier 23b.

Thus, the difference of displacement in the X-axis direction, caused by the angular acceleration about the Z axis, between the first and second proof mass section 8A, 8B paired with each other can be detected to determine the magnitude of the angular acceleration.

Here, if an acceleration in the X-axis direction is applied, the first and second proof mass section 8A, 8B are displaced by the same amount in the X-axis direction. Hence, these displacements are canceled out in the process of obtaining the difference by the differential amplifier 23b, and only the angular acceleration component about the Z axis is determined.

On the other hand, under application of impact load, the inertial sensor 610 provides similar performance to that of the inertial sensors according to the embodiments described above. More specifically, the structural strength is high in the Y-axis direction, and there is no problem with impact load applied in the Y-axis direction. When an impact load is applied in the X-axis direction, the first and second proof mass section 8A, 8B are brought into contact with the side surface stopper section 10 and restricted in its bending deformation, which can prevent the first and second detecting section 2A, 2B and the like from being broken by application of excessive stress. Furthermore, when an impact load is applied in the Z-axis direction, the first and second proof mass section 8A, 8B are brought into contact with the substrate 1 or the upper surface stopper section 17 and restricted in its bending deformation, which can prevent the first and second detecting section 2A, 2B and the like from being broken by application of excessive stress.

Thus, the inertial sensor 610 according to this embodiment can realize an inertial sensor being sensitive to angular acceleration in the Z-axis and X-axis direction and having sufficient resistance to impact force in the X-axis, Y-axis, and Z-axis direction.

As is clear from the description of this embodiment, in the inertial sensor 610, the first and second proof mass section 8A, 8B are displaced by angular acceleration about the X axis, angular acceleration about the Z axis, acceleration in the X-axis direction, and acceleration in the Z-axis direction. Among them, the circuit illustrated in FIG. 27 can detect the angular acceleration about the X axis and the angular acceleration about the Z axis.

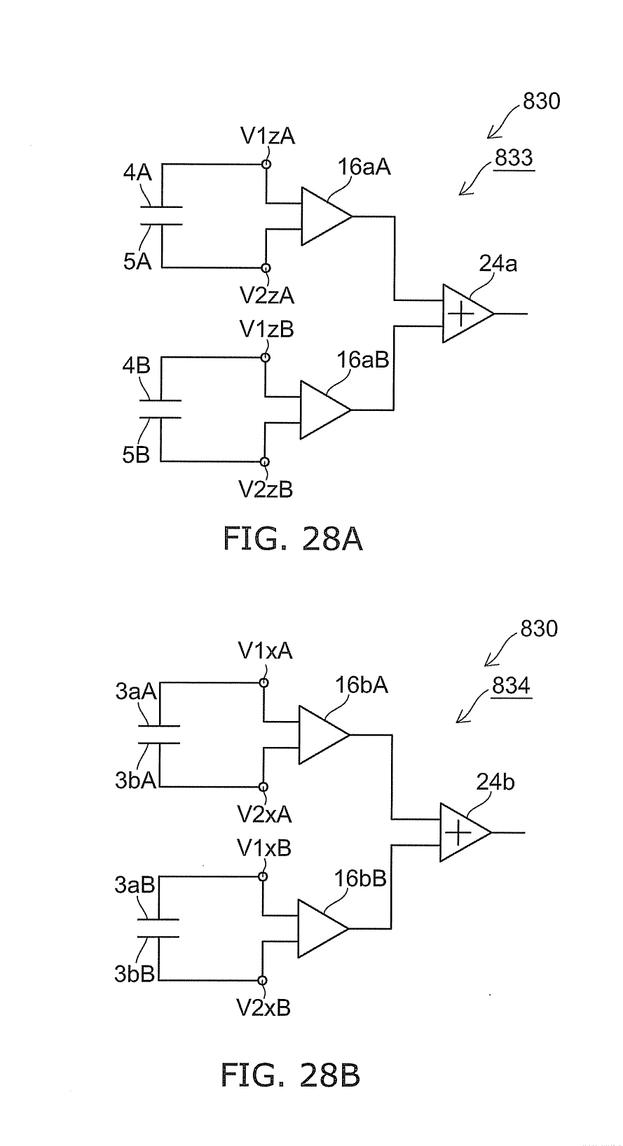

FIG. 28 is a circuit diagram illustrating an alternative circuit connected to the inertial sensor according to the sixteenth embodiment of the invention.

As shown in FIG. 28, in the alternative circuit connected to the inertial sensor according to the sixteenth embodiment of the invention, the differential amplifiers 23a, 23b in the circuit illustrated in FIG. 27 are replaced by summing amplifiers 24a, 24b.

As shown in FIG. 28A, the detecting circuit 833 cancels out the outputs resulting from the angular acceleration about the X axis and sums the outputs resulting from the acceleration in the Z-axis direction, achieving high-accuracy measurement.

Likewise, as shown in FIG. 28B, the detecting circuit 834 cancels out the outputs resulting from the angular acceleration about the Z axis and sums the outputs resulting from the acceleration in the X-axis direction, achieving high-accuracy measurement.

Thus, in the inertial sensor 610 of this embodiment, two types of detecting circuits 831, 832, 833, 834 in FIGS. 27 and 28 can be used to construct a biaxial angular accelerometer and a high-accuracy accelerometer insusceptible to angular acceleration.

In this embodiment, two copies of the inertial sensor 150 according to the fifth embodiment are combined to construct an inertial sensor for measuring angular acceleration and acceleration with high accuracy. However, any two of the aforementioned inertial sensors according to the embodiments and practical example of the invention can be combined to construct an inertial sensor for measuring angular acceleration and acceleration with high accuracy.

### Seventeenth Embodiment

The inertial detecting device according to the seventeenth embodiment of the invention is an inertial detecting device which can detect angular acceleration.

The inertial detecting device 830 according to the seventeenth embodiment of the invention illustratively includes the inertial sensor 610 according to the sixteenth embodiment of the invention, and a detecting circuit connected to at least one of the first electrode 3 and the second electrode 4 of the inertial sensor.

The detecting circuit can illustratively be at least one of the differential amplifier circuits 16aA, 16aB, 16bA, 16bB, 23a, 23b described in the sixteenth embodiment. Furthermore, the detecting circuit can illustratively be at least one of the summing amplifier circuits 24a, 24b described in the sixteenth embodiment.

In the inertial detecting device 830 according to this embodiment, any of the aforementioned inertial sensors can be used as long as technically applicable.

The detecting circuit is connected to at least one of the first electrode 3, the second electrode 4, and the third electrode 5.

In the case where at least one of the first electrode 3, the second electrode 4, and the third electrode 5 includes split electrodes, the detecting circuit can be connected to each of the split electrodes.

Thus, the inertial detecting device 830 according to this embodiment including the inertial sensor according to the embodiments of the invention and a detecting circuit can provide an ultrasmall inertial detecting device for detecting angular acceleration, which is capable of high-accuracy detection without temperature compensation and easy to manufacture.

At least part of the detecting circuit described above can be provided on the substrate 1 where the aforementioned inertial sensor is provided. This serves to realize an inertial detecting device with low noise, high sensitivity, and high accuracy.

The embodiments of the invention have been described with reference to examples. However, the invention is not limited to these examples. For instance, various specific configurations of the components constituting the inertial sensor and the inertial detecting device are encompassed within the scope of the invention as long as those skilled in the art can similarly practice the invention and achieve similar effects by suitably selecting such configurations from conventionally known ones.

Furthermore, any two or more components of the examples can be combined with each other as long as technically feasible, and such combinations are also encompassed within the scope of the invention as long as they fall within the spirit of the invention.

Furthermore, those skilled in the art can suitably modify and implement the inertial sensor and the inertial detecting device described above in the embodiments of the invention, and any inertial sensor and inertial detecting device thus modified are also encompassed within the scope of the invention as long as they fall within the spirit of the invention.

Furthermore, those skilled in the art can conceive various modifications and variations within the spirit of the invention, and it is understood that such modifications and variations are also encompassed within the scope of the invention.

1. An inertial sensor comprising:
a first beam extending in a first direction in a plane parallel to a major surface of a substrate, held with a spacing from the major surface of the substrate, and having a first detecting section including a first upper side electrode, a first lower side electrode, and a first upper side piezoelectric film provided between the first upper side electrode and the first lower side electrode, the first beam having one end connected to the major surface of the substrate;
a first proof mass section connected to other end of the first beam and held with a spacing from the major surface of the substrate; and
a first upper surface stopper section provided on the opposite side of the first proof mass section from the substrate with a spacing from the first proof mass section.

2. The sensor according to claim 1, wherein the first proof mass section includes a film which is continuous with at least one of the first upper side electrode, the first lower side electrode, and the first upper side piezoelectric film.

3. The sensor according to claim 1, wherein the first detecting section and the first proof mass section are formed generally coplanarly.

4. The sensor according to claim 1, wherein center of gravity of the first proof mass section is located between a first plane including the first upper side electrode and a second plane including the first lower side electrode.

5. The sensor according to claim 1, wherein the first detecting section and the first proof mass section are formed axisymmetrically with respect to the first direction.

6. The sensor according to claim 1, further comprising:
a first side surface stopper section opposed to a side surface of the first proof mass section and spaced by a gap from the side surface of the first proof mass section.

7. The sensor according to claim 6, wherein the first side surface stopper section includes a layer which is continuous with at least one of the first upper side electrode, the first lower side electrode, and the first upper side piezoelectric film.

8. The sensor according to claim 1, wherein at least one of the first upper side electrode and the first lower side electrode includes a plurality of split electrodes extending in the first direction.

9. The sensor according to claim 1, wherein the first upper side piezoelectric film contains a compound of a metal contained in both of the first upper side electrode and the first lower side electrode.

10. The sensor according to claim 1, wherein the first detecting section further includes a first substrate-side electrode provided on the opposite side of the first lower side electrode from the first upper side piezoelectric film, and a first lower side piezoelectric film provided between the first substrate-side electrode and the first lower side electrode.

11. The sensor according to claim 10, wherein at least one of the first upper side electrode and the first substrate-side electrode includes a plurality of split electrodes extending in the first direction.

12. The sensor according to claim 10, wherein the first upper piezoelectric film and the first lower side piezoelectric film are polarizable in the same direction in a plane perpendicular to the major surface.

13. The sensor according to claim 10, wherein the first proof mass section includes a layer which is continuous with at least one of the first upper side electrode, the first lower side electrode, the first substrate-side electrode, the first upper side piezoelectric film, and the first lower side piezoelectric film.

14. The sensor according to claim 1, further comprising:
a second beam extending in a second direction in a plane parallel to a major surface of a substrate and non-parallel to the first direction, held with a spacing from the major surface of the substrate, and having a second detecting section including a second upper side electrode, a second lower side electrode, and a second upper side piezoelectric film provided between the second upper side electrode and the second lower side electrode, the second beam having one end connected to the major surface of the substrate;
a second proof mass section connected to other end of the second beam and held with a spacing from the major surface of the substrate; and
a second upper surface stopper section provided on the opposite side of the second proof mass section from the substrate with a spacing from the second proof mass section.

15. The sensor according to claim 1, further comprising:
a second beam extending in the first direction, held with a spacing from the major surface of the substrate, and having a second detecting section including a second upper side electrode, a second lower side electrode, a second upper side piezoelectric film provided between the second upper side electrode and the second lower side electrode, a second substrate-side electrode provided on the opposite side of the second lower side electrode from the second upper side piezoelectric film, and a second lower side piezoelectric film provided between the second substrate-side electrode and the second lower side electrode, the second beam having one end connected to the major surface of the substrate;
a second proof mass section connected to other end of the second beam and held with a spacing from the major surface of the substrate; and
a second upper surface stopper section provided on the opposite side of the second proof mass section from the substrate with a spacing from the second proof mass section.

16. The sensor according to claim 1, further comprising:
a second beam extending in a second direction in a plane parallel to a major surface of a substrate and non-parallel to the first direction, held with a spacing from the major surface of the substrate, and having a second detecting section including a second upper side electrode, a second lower side electrode, a second upper side piezoelectric film provided between the second upper side electrode and the second lower side electrode, a second substrate-side electrode provided on the opposite side of the second lower side electrode from the second upper side piezoelectric film, and a second lower side piezoelectric film provided between the second substrate-side electrode and the second lower side electrode, the second beam having one end connected to the major surface of the substrate;
a second proof mass section connected to other end of the second beam and held with a spacing from the major surface of the substrate; and
a second upper surface stopper section provided on the opposite side of the second proof mass section from the substrate with a spacing from the second proof mass section,
at least one of the second upper side electrode and the second substrate-side electrode including a plurality of split electrodes extending in the second direction,

17. The sensor according to claim 1, further comprising:
a second beam extending in a second direction in a plane parallel to a major surface of a substrate and non-parallel to the first direction, held with a spacing from the major surface of the substrate, and having a second detecting section including a second upper side electrode, a second lower side electrode, and a second upper side piezoelectric film provided between the second upper side electrode and the second lower side electrode, the second beam having one end connected to the major surface of the substrate;
a second proof mass section connected to other end of the second beam and held with a spacing from the major surface of the substrate;
a second upper surface stopper section provided on the opposite side of the second proof mass section from the substrate with a spacing from the second proof mass section;
a third beam extending in the first direction, held with a spacing from the major surface of the substrate, and having a third detecting section including a third upper side electrode, a third lower side electrode, a third upper side piezoelectric film provided between the third upper side electrode and the third lower side electrode, a third substrate-side electrode provided on the opposite side of the third lower side electrode from the third upper side piezoelectric film, and a third lower side piezoelectric film provided between the third substrate-side electrode and the third lower side electrode, the third beam having one end connected to the major surface of the substrate;
a third proof mass section connected to other end of the third beam and held with a spacing from the major surface of the substrate; and
a third upper surface stopper section provided on the opposite side of the third proof mass section from the substrate with a spacing from the third proof mass section.

18. The sensor according to claim 1, further comprising:
a second beam extending in the first direction, held with a spacing from the major surface of the substrate, and having a second detecting section including a second upper side electrode, a second lower side electrode, and a second upper side piezoelectric film provided between the second upper side electrode and the second lower side electrode, the second beam having one end connected to the major surface of the substrate;
a second proof mass section connected to other end of the second beam and held with a spacing from the major surface of the substrate; and
a second upper surface stopper section provided on the opposite side of the second proof mass section from the substrate with a spacing from the second proof mass section,
the first detecting section and the first proof mass section being axisymmetric to the second detecting section and the second proof mass section with respect to a direction perpendicular to the first direction.

19. An inertial detecting device comprising:
an inertial sensor including:
a first beam extending in a first direction in a plane parallel to a major surface of a substrate, held with a spacing from the major surface of the substrate, and having a first detecting section including a first upper side electrode, a first lower side electrode, and a first upper side piezoelectric film provided between the first upper side electrode and the first lower side electrode, the first beam having one end connected to the major surface of the substrate;
a first proof mass section connected to other end of the first beam and held with a spacing from the major surface of the substrate; and
a first upper surface stopper section provided on the opposite side of the first proof mass section from the substrate with a spacing from the first proof mass section; and
a detecting circuit connected to at least one of the first upper side electrode and the first lower side electrode.

20. The device according to claim 19, further comprising:
an oscillating circuit connected to at least one of the first upper side electrode, the first lower side electrode, and a first substrate-side electrode,
the first detecting section further including the first substrate-side electrode provided on the opposite side of the first lower side electrode from the first upper side piezoelectric film, and a first lower side piezoelectric film provided between the first substrate-side electrode and the first lower side electrode, and
the detecting circuit being connected to at least one of the first upper side electrode, the first lower side electrode, and the first substrate-side electrode.
